(19) United States
(12) Patent Application Publication
(10) Pub. No.: US 2026/0289118 A1
(43) Pub. Date: Sep. 24, 2026

(54) SYSTEM

(71) Applicant: SoftBank Group Corp., Tokyo (JP)

(72) Inventor: Daiki KURODA, Tokyo (JP)

(73) Assignee: SoftBank Group Corp., Tokyo (JP)

(21) Appl. No.: 19/567,022

(22) Filed: Mar. 14, 2026

(30) Foreign Application Priority Data
Mar. 19, 2025 (JP) 2025-045285

(51) Int. Cl. G06F 40/279; G06F 40/205; G06F 40/40; G06Q 50/18

(52) U.S. Cl. CPC G06F 40/279; G06F 40/205; G06F 40/40; G06Q 50/18

(57) ABSTRACT

A system includes a processor that is configured to analyze a legal text by using a natural language processing technique, summarize the analyzed legal text by using a generative artificial intelligence model by requesting generation of a summary based on a prompt text in order to extract important information, and recognize a user emotion and adjust a method of summarizing the legal text in accordance with the user emotion by using an emotion engine.

### CROSS-REFERENCE TO RELATED APPLICATION

This application is based on and claims priority under 35 USC 119 from Japanese Patent Application No. 2025-045285 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for presenting legal texts to users suffer from several problems. First, legal texts are typically written in highly formal and complex language, often including rigid expressions, intricate numerical expressions, and sentences containing multiple nested parentheses. As a result, general users, and even professionals, encounter difficulty in quickly understanding the essence of legal obligations, conditions, and exceptions from the original texts.
Second, existing summarization and information retrieval systems generally provide only simple keyword-based extraction or rule-based simplifications that do not adequately capture the core legal meaning. Summaries generated by such systems are often either too verbose, including unnecessary legal formalities, or too shallow, omitting important conditions and limitations. Accordingly, these summaries are frequently less accurate and less useful than explanations provided by human experts.
Third, conventional systems do not flexibly adapt to the emotional state or cognitive burden of the user. In particular, when a user is anxious, confused, or stressed about legal matters, existing systems continue to present legal information in a uniform manner without considering the user's emotional context. This lack of personalization can further reduce the user's ability to correctly and efficiently grasp the content of legal texts.

Therefore, there is a need for a system that can accurately analyze legal texts using natural language processing, generate concise and appropriate summaries by using a generative AI model, and further adjust the manner of summarization in accordance with the user's emotional state so that the user can more easily and reliably understand the essential content of legal texts.

### SUMMARY

In order to solve the above-described problems, a system according to one aspect of the present invention comprises a processor, wherein the processor is configured to analyze a legal text by using a natural language processing technique, summarize the analyzed legal text by using a generative artificial intelligence model by requesting generation of a summary based on a prompt text in order to extract important information, and recognize a user emotion and adjust a method of summarizing the legal text in accordance with the user emotion by using an emotion engine.

More specifically, the processor first performs linguistic and structural analysis of the legal text by applying natural language processing techniques. Through this analysis, the processor identifies syntactic and semantic structures within the legal text, including subjects, obligations, prohibitions, conditions, temporal expressions, and references. The processor is thereby able to handle texts containing formal expressions, numerical expressions, and sentences having a plurality of nested parentheses, and to convert such complex structures into an internal representation suitable for further processing.

Next, the processor generates a summary of the analyzed legal text by using a generative artificial intelligence model. In this step, the processor constructs a prompt text that describes, for example, the type of legal document, the desired level of detail, the focus on obligations or deadlines, and the requirement to extract important information. The processor requests the generative artificial intelligence model to produce a summary based on the prompt text so that essential information, such as key obligations, actors, time limits, and conditions, is extracted and clearly presented. As a result, the system can summarize and list up the legal text more concisely than a human expert and more appropriately than text information displayed by an information retrieval system.

Furthermore, the processor employs an emotion engine to recognize the emotion of the user, for example, by analyzing user inputs, interaction patterns, or biometric signals provided from an external sensor. Based on the recognized user emotion, the processor adjusts the method of summarizing the legal text. For instance, when the user is anxious or confused, the processor may generate a more detailed and gentle explanation, avoid overly technical terminology, and provide additional contextual clarifications. When the user is calm and experienced, the processor may generate a more compact summary focusing on key points only. By dynamically controlling the summarization style and depth in accordance with the user's emotional state, the system enables the user to more easily, efficiently, and reliably understand the essential content of legal texts.
The term “system” refers to an arrangement including at least one processor and, where applicable, one or more memories, communication interfaces, input/output devices, or external services, which cooperate to perform the functions described in the claims.
The term “processor” refers to any hardware component or combination of components that executes instructions, such as a central processing unit (CPU), a graphics processing unit (GPU), a digital signal processor (DSP), a microcontroller, a programmable logic device, or a combination thereof.
The term “legal text” refers to any text expressing legal content, including but not limited to statutes, regulations, ordinances, administrative guidelines, court decisions, contracts, and official notices.
The term “natural language processing technique” refers to any computational method or algorithm for analyzing, interpreting, or transforming human language text, including but not limited to tokenization, morphological analysis, syntactic parsing, semantic analysis, named entity recognition, and coreference resolution.
The term “generative artificial intelligence model” refers to a machine-learned model that is configured to generate text or other content in response to an input, such as a large language model or other neural network trained to produce natural language output.
The term “prompt text” refers to a text input provided to the generative artificial intelligence model that specifies conditions, instructions, or constraints for generating a summary, including for example the type of information to be extracted or the desired level of detail.
The term “summary” refers to text generated by the generative artificial intelligence model that expresses, in a shortened and simplified form, at least a portion of the content of the legal text while retaining essential information.
The term “important information” refers to information contained in the legal text that is relevant to understanding legal obligations, rights, conditions, exceptions, time limits, subjects, or other key legal elements.
The term “user emotion” refers to an emotional state of a user, such as anxiety, confusion, calmness, confidence, frustration, or interest, which can be inferred or estimated from user behavior, input content, biometric data, or other observable signals.
The term “emotion engine” refers to a functional module implemented by hardware, software, or a combination thereof, which is configured to recognize or estimate a user emotion and to output information representing the recognized or estimated user emotion for use in controlling other processing.
The term “formal expressions” refers to rigid or highly conventionalized expressions used in legal drafting or official documents, including honorific phrases, formulaic clauses, and fixed legal wordings that differ from everyday language.
The term “numerical expressions” refers to expressions representing quantities, numbers, times, dates, periods, or monetary amounts, including those written in Arabic numerals, Kanji numerals, or combinations thereof.
The term “sentences having a plurality of nested parentheses” refers to sentences that include two or more levels of parentheses or brackets, in which a parenthetical expression is contained within another parenthetical expression, thereby creating a nested structure.
The term “list up” refers to presenting one or more items, such as summarized legal obligations or provisions, in a structured form, for example in a list, table, or ordered sequence, that allows a user to view and compare the items.
The term “information retrieval system” refers to a system that provides text information in response to user queries by searching databases or document collections, including but not limited to web search engines and specialized legal search systems.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

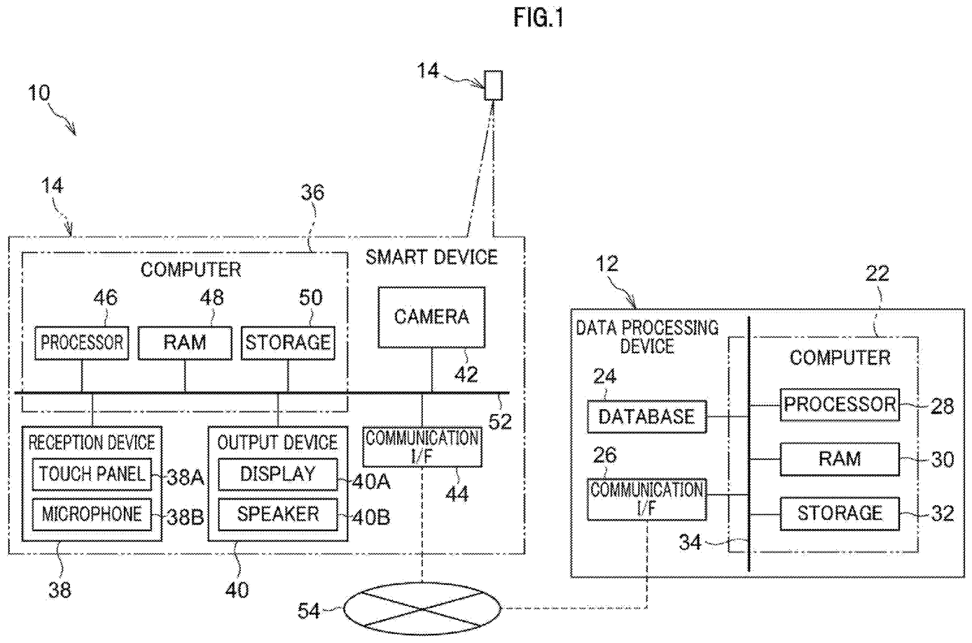

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

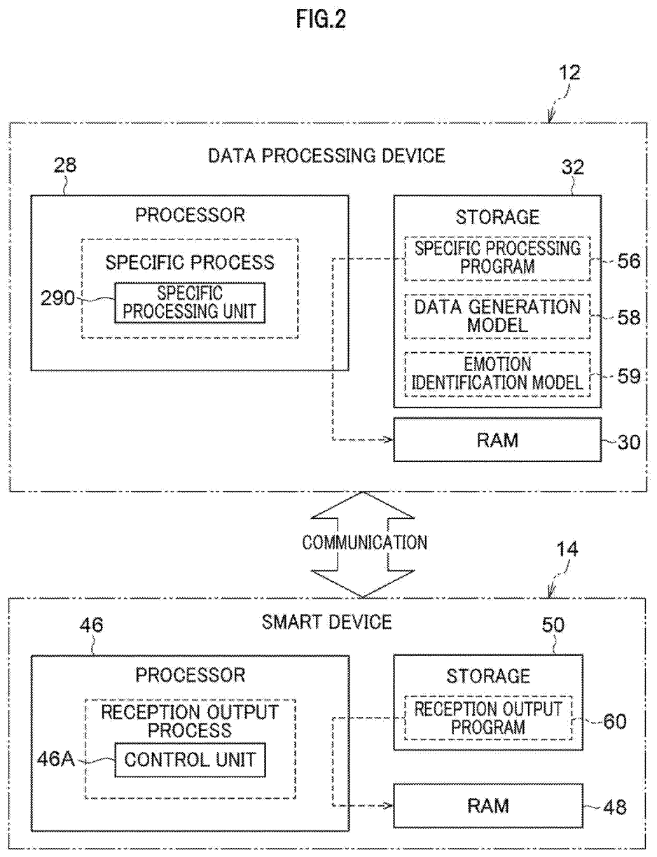

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented techniques for processing statutory documents suffer from several technical limitations when operating on complex, real-world legal texts. A statutory document typically includes formal expressions, nested parenthetical structures, mixed numeric and non-numeric date expressions, and multiple effective dates and deadlines interleaved throughout the text. Existing natural language processing pipelines running on general-purpose processors are often unable to reliably extract machine-usable date information and contextual legal attributes from such complex input. As a result, server-side systems cannot consistently normalize effective dates and application deadlines into internal data formats suitable for structured storage, chronological sorting, and efficient retrieval.

Further, conventional text summarization systems that rely on generic natural language models or fixed rule-based methods do not effectively leverage intermediate syntactic analysis results or normalized deadline information when generating summaries. These systems typically pass raw text directly to a model, which leads to summaries that omit critical temporal information, misinterpret jurisdictional scope, or fail to align with downstream database schemas. Consequently, the generated summaries cannot be robustly linked to enforcement dates or application deadlines in a database, which impairs the ability of the server to generate accurate, time-ordered lists of statutory provisions.

Moreover, existing server systems do not dynamically adapt the summarization process to the emotional state or cognitive load of the user. In practice, the same statutory content may need to be presented in different levels of abstraction or in different tones depending on whether a user is confused, anxious, or seeking highly technical detail. Conventional systems lack an integrated emotion processing mechanism that adjusts prompt sentences for a generative AI model or modifies the representation format of the summary result based on detected user emotion. This leads to a mismatch between the server's output and the user's real-time needs, reducing usability and increasing the time and computational resources consumed by repeated, trial-and-error queries.

These limitations manifest as concrete technical problems in computer systems that process statutory documents: the server cannot reliably transform complex unstructured input into normalized, structured representations; cannot efficiently coordinate natural language processing components, generative AI models, and database engines; and cannot optimize interactive response generation to reduce redundant processing and network traffic. There is a need for a server-side architecture and processing method in which the processor is specifically configured to (i) perform deep syntactic analysis of statutory documents, (ii) extract and normalize temporal information into an internal representation, (iii) construct context-rich prompt sentences for a generative AI model based on those analysis results, (iv) store summary and deadline information in a data storage device for chronological retrieval, and (v) adapt the form of prompt sentences and summary outputs to the user's emotional state, thereby improving the overall efficiency, reliability, and user relevance of the computer system.

The specific processing by the specific processing unit 290 of the data processing device 12 in Example 1 is realized by the following means.

The present invention provides a server comprising a processor configured to analyze statutory documents by using a natural language processing technique to extract linguistic elements including date expressions and deadline-related phrases, to normalize effective dates and application deadlines into an internal data format, to generate prompt sentences for a generative AI model based on syntactic analysis results and normalized deadline information, to request the generative AI model to perform summary generation and important information extraction using the prompt sentences, to associate and store summary results with the corresponding deadline information in a data storage device, to sort the stored statutory documents in chronological order based on the effective dates or application deadlines and output the sorted results as a list, and to recognize an emotional state of a user and adjust at least one of the prompt sentences and a representation format of the summary results according to the emotional state. This enables the server to convert complex statutory text into structured, time-aware summaries that are efficiently stored and retrieved in chronological order, to coordinate natural language processing and generative AI components in a manner tailored to downstream database operations, and to dynamically adapt interactive responses to the user's emotional state, thereby improving the technical performance, robustness, and user-oriented effectiveness of the computer-based statutory processing system.
The term “statutory document” refers to a machine-readable text document that expresses legally binding provisions, including laws, regulations, rules, ordinances, or similar normative texts issued by an authority.
The term “natural language processing technique” refers to a computational procedure executed by a processor to analyze, interpret, or transform human language text, including operations such as tokenization, part-of-speech tagging, syntactic parsing, named entity recognition, and semantic analysis.
The term “linguistic element” refers to a unit of text derived from a natural language processing technique, including a token, phrase, clause, named entity, or other structural component recognized within a statutory document.
The term “date expression” refers to a segment of text that indicates a point in time or a time range, including expressions based on calendar dates, legal eras, or mixed numeric and non-numeric formats.
The term “deadline information” refers to structured data indicating a temporal limit or boundary associated with legal validity or applicability, including an effective date, an application deadline, an expiration date, or a similar legally relevant date.
The term “effective date” refers to a specific date on which a statutory provision or a part of a statutory document becomes legally operative or enforceable.
The term “application deadline” refers to a specific date by which a particular legal condition, application, filing, or compliance action must be completed under a statutory document.
The term “internal format” refers to a machine-usable representation of data, such as a normalized date format or a structured record, that is suitable for computational processing, storage, sorting, and retrieval by a computer system.
The term “generative information processing model” refers to a machine learning model configured to generate text or other data in response to input, based on patterns learned from training data, including generative AI models used for summarization or information extraction.
The term “prompt sentence” refers to a text string or set of instructions supplied as input to a generative information processing model to specify a task, context, or output constraints for generating a response.
The term “summary result” refers to a text output generated by a generative information processing model that presents essential information from a statutory document in a condensed and more easily understandable form.
The term “data storage device” refers to a hardware and software combination used to store digital information, including a database system, non-volatile memory, magnetic storage, or solid-state storage, accessible by a processor.
The term “chronological order” refers to an arrangement of items based on time-related values, such that items are ordered by effective dates, application deadlines, or other temporal attributes from earlier to later, or vice versa.
The term “information terminal apparatus” refers to an end-user computing device capable of communication with the server, including a smartphone, tablet, personal computer, or similar electronic device with input and display functions.
The term “emotional state” refers to a condition representing a user's affective or psychological status, such as confusion, anxiety, confidence, or interest level, as inferred by a computing system from user behavior, input content, biometric data, or other signals.
The term “emotion processing mechanism” refers to a computational module or set of algorithms configured to estimate, classify, or respond to a user's emotional state and to modify system behavior, including prompt sentence generation or summary formatting, based on that state.
The term “interactive processing” refers to a sequence of operations in which a system exchanges information with a user in multiple steps, processes user requests or inquiries, and dynamically adapts responses in real time or near real time based on the user's input or context.

In one embodiment, a server implements the claimed system as a network-accessible application that cooperates with at least one terminal operated by a user. The server includes a processor, a memory, a network interface, and a non-transitory storage device. The server executes an operating system such as a Unix-like operating system, and runs an application stack including an application server framework such as a web framework implemented in a high-level programming language, a natural language processing (NLP) library such as spaCy, a client library for accessing a generative AI model, and a database interface library for accessing a relational database management system such as a relational database server.

The server uses the processor and memory to load an NLP model from the NLP library into RAM at startup. In one embodiment, the server loads a Japanese language model, which includes tokenization rules, a part-of-speech tagger, a dependency parser, and a named entity recognizer trained on legal or formal text. The server stores this NLP model as an in-memory object so that repeated invocations do not require reloading from disk, thereby reducing latency and improving throughput for multiple concurrent user requests.

The server stores statutory documents and associated metadata in a relational database running on the relational database server. The server defines data structures such as a “statutes” table that includes at least the following fields: a primary key identifier, a raw_text field for the original statutory document, a summary_text field for a summary result, an enforcement_date field, an application_deadline field, an expiration_date field, an emotion_profile field, a created_at field, and an updated_at field. The server indexes the enforcement_date and application_deadline fields so that the database can efficiently execute ORDER BY operations on those fields. By defining these fields with explicit date types, the server enables efficient chronological sorting and range queries that would not be feasible with purely unstructured text.

The server uses the NLP model to analyze statutory documents and extract linguistic elements, especially date expressions and deadline-related phrases. The server runs tokenization and dependency parsing to segment the text into tokens and identify grammatical relations. The server applies named entity recognition to detect candidate date entities. The server further executes rule-based components using regular expressions and deterministic finite automata to detect era-based dates and nested parenthetical constructs that are common in statutory documents. For example, the server identifies textual patterns such as “Loses validity as of Apr. 1, 2021“or ” Loses validity as of Mar. 31, 2023.” by matching era markers, year markers, month markers, and day markers, as well as specific verbs that indicate enforcement, expiration, or limitation.

The server converts the detected date expressions into an internal format using a date normalization module. The server stores a mapping table from legal eras to Gregorian calendar years and uses arithmetic conversion to derive an absolute year. The server then constructs a normalized date object with year, month, and day components and serializes this object into a standardized string format such as YYYY-MM-DD. The server assigns each normalized date to a semantic category such as “enforcement date,” “application deadline,” or “expiration date” based on the syntactic context and proximity to trigger phrases identified by the dependency parser. This step involves inspecting the parse tree and dependency labels to ensure that the correct predicate (“to come into force,” “to apply until,” “to lose effect”) is associated with the date phrase. This structured assignment improves technical accuracy compared with naive keyword-based extraction and reduces misclassification of dates.

The server constructs prompt sentences for a generative AI model based on the NLP analysis and normalized deadline information. The server uses the processor to combine: (i) the original statutory text, (ii) the syntactic analysis results, and (iii) the normalized dates into a structured prompt. The server includes explicit instructions regarding output length, language, focus on enforcement and expiration dates, and desired granularity. In one embodiment, the server generates prompt sentences such as:
“You are a legal assistant. Please summarize the following statute and clearly state the enforcement date and any expiration or application deadlines. Convert all dates to the Gregorian calendar format YYYY-MM-DD. Statute: This Law shall come into force as from Apr. 1, 2021.”
“Please summarize the following statute text for non-expert users and extract the key enforcement and expiration dates. Output no more than five sentences. Text: Article 1: This Law shall . . . (omitted) . . . Article 10: This Law shall lose its validity as of Mar. 31, 2023.”
“List all enforcement and expiration dates contained in the following statutory document, and describe in one sentence what legal effect each date has. Use the format ‘YYYY-MM-DD: description’. Statute: ‘. . . ’”

By combining pre-analyzed syntactic information and normalized dates in the prompt sentence, the server constrains the generative AI model to operate on a pre-structured representation rather than raw text alone. This reduces the ambiguity the model must resolve internally, which leads to more accurate and consistent summaries and date interpretations, and directly improves the reliability of downstream database operations.

In one embodiment, the server uses a generative AI model implemented as a transformer-based neural network. The model includes multiple layers of self-attention blocks, feed-forward networks, and layer normalization. The server accesses this model through an API provided by a model-serving infrastructure that accepts prompt sentences as input and returns generated text as output. The transformer architecture uses multi-head attention to compute contextualized representations of each token in the prompt. During training of such a model, a large corpus of text, including legal texts and general domain documents, is processed using a language modeling objective such as minimizing cross-entropy loss between predicted next tokens and actual tokens. The model weights are updated using gradient-based optimization methods such as Adam or AdamW, with backpropagation through time applied across the transformer layers.

The server benefits from this architecture in several technical ways. The server can offload complex language generation and abstraction tasks to the generative AI model while it focuses on pre-processing, structural normalization, and post-processing tailored to statutory documents. The server imposes constraints on the generative AI model's behavior by controlling parameters such as maximum number of tokens, temperature, and top-k or top-p sampling thresholds. By doing so, the server reduces output variance and prevents excessively long responses, which directly reduces network payload size and memory consumption on both the server and the terminal, thereby lowering communication load and improving response time.

The server integrates an emotion processing mechanism that influences prompt sentence formation and summary presentation. The server receives from the terminal various signals such as user interaction patterns (e.g., rapid scrolling, repeated requests for simplification), explicit feedback text (“I do not understand”), or biometric data if available and permitted (e.g., heart rate, facial expression analysis performed on the terminal). The server applies an emotion classification algorithm that may be implemented as a neural network classifier or a probabilistic model trained on labeled interaction data. The classifier outputs an estimated emotional state label such as “confused,” “stressed,” or “confident.”

The server stores the emotion profile in association with the statutory document or user session in the database. The server uses this emotion profile when generating prompt sentences. For example, if the user is classified as “confused,” the server modifies the prompt sentence to request simpler language, shorter sentences, and more examples:
“Please explain the following statute in very simple language for a non-expert user who is currently confused. Avoid legal jargon and provide one concrete example. Statute: ‘. . . ’ ”

If the user is classified as “confident” or “expert,” the server requests a more technical summary:
“Please summarize the following statute for a practitioner-level audience, preserving technical terms and citing key legal concepts. Statute: ‘. . . ’”

This mechanism is not a mere presentation change; it alters the actual prompt sentence structure and the constraints imposed on the generative AI model, which in turn modifies the internal attention patterns and output distribution of the model. As a result, the server achieves improved communication efficiency: the user is more likely to understand the summary on the first attempt, thereby reducing the number of repeated queries, lowering the total number of generative AI invocations, and decreasing overall computational load.

The server performs post-processing of the summary results from the generative AI model to ensure structural consistency with the database schema. The server applies additional NLP steps, such as tokenization and date detection, to the generated text to verify that all referenced dates match the normalized dates previously extracted. If discrepancies are detected, the server can either request a corrected summary by issuing a secondary prompt sentence that highlights the inconsistency, or it can adjust the summary text locally by substituting normalized date values. This feedback mechanism closes the loop between pre-analysis and post-analysis, improving the robustness of the overall system against model hallucinations or misinterpretations.

The server uses deterministic algorithms to merge the summary result and deadline information into the database. The server assigns each summary to a statute identifier and stores both the raw statutory text and the summary result. The server ensures referential integrity by enforcing constraints such as unique keys and foreign key relationships between a “statutes” table and auxiliary tables (for example, “dates” or “emotions” tables). By structuring the data in this way, the server can execute complex queries such as “select all statutes with enforcement dates in the next 30 days” or “select all statutes that expire within the current fiscal year” in logarithmic or near-logarithmic time with respect to the number of stored records, which is a technical improvement over purely text-based searches.

The server generates time-ordered lists of statutory summaries by issuing queries that sort on the enforcement_date or application_deadline fields. Because the server stored dates in normalized internal format and indexed date fields, the database engine can perform efficient range scans without scanning the full table. The server then formats the query results into a compact representation suitable for transmission to the terminal. The server may compress the response data using a standard compression algorithm or employ pagination to limit the number of records per response, further reducing communication bandwidth and latency.

The terminal functions as an interface device that communicates with the server over a network. The terminal presents graphical user interfaces that allow the user to input statutory text, select processing options, and view summary results and lists. The terminal can be implemented as a smartphone, tablet, or personal computer. The terminal sends the statutory text and descriptive options (for example, “summarize for non-expert,” “prioritize enforcement dates”) to the server. The terminal also receives from the server the time-ordered lists and summary results, which it renders on a display. The terminal may perform local processing such as extracting facial expression features or interaction metrics and sending derived features to the server as part of the emotion estimation pipeline, but the main NLP and generative AI processing runs on the server.

The user provides statutory documents to the system by copying and pasting text, uploading files that the terminal converts into text, or manually typing the content. The user may also input direct prompt sentences to influence the generative AI model via the server, such as: “Please tell me the enforcement date of this law based on the following text: Article 123 (Date of enforcement) This Law shall come into force as from Apr. 1, 2021.” “Please summarize the following law and list the important points, including who is affected and from when it applies: ‘. . . ’ ”
“Please list the statutes in order of the closest enforcement date.”

The server interprets these user prompt sentences, combines them with its own internally generated prompt sentences containing structured analysis, and sends composite prompts to the generative AI model. This layered prompting strategy allows the server to incorporate both user intent and machine-derived structure, which results in improved alignment between the model's output and the system's data structures.

The system provides technical advantages beyond mere automation of human reading. The server's combination of (i) deep syntactic parsing, (ii) rule-based date normalization, (iii) structured prompt construction, (iv) database-aligned post-processing, and (v) emotion-aware adaptation leads to measurable improvements in processing speed, accuracy of date extraction, and reduction of erroneous summaries. The server reduces computational complexity by avoiding repeated full re-parsing of texts on each user request; instead, the server caches intermediate representations and reuses normalized dates and parse trees when generating new summaries or lists. The server also reduces network traffic by minimizing the length and number of generative AI model calls through optimized prompts and emotion-aware tailoring, which decreases the need for follow-up queries.

In alternative embodiments, the server can employ different NLP libraries, such as other syntactic parsers or custom-trained models, provided that the server still executes syntactic analysis and named entity recognition sufficient to extract date expressions and structural information. The generative AI model can be replaced by any transformer-based or recurrent neural network-based text generation model that accepts prompt sentences and produces summaries. The emotion processing mechanism can use various classifiers, such as support vector machines, convolutional neural networks applied to interaction sequences, or recurrent networks analyzing time-series features. The database system can be implemented as a distributed database, a columnar store, or a key-value store, provided that the server maintains fields allowing chronological sorting of deadlines.

The server can adjust internal thresholds and parameters dynamically based on system load or error statistics. For example, the server can lower the maximum output length for summaries during periods of high load to reduce CPU time and bandwidth usage, or increase the strictness of post-processing date verification when it detects a high error rate in past summaries. The server can log performance metrics such as response time, error rate in date extraction, and number of user retries, and use these metrics to update configuration parameters. This feedback loop constitutes a technical optimization of the server's internal operation, improving efficiency and reliability in a way that would not be achievable with static rule sets or manual human summarization.

Through these mechanisms, the server, the terminal, and the user cooperate in a computer-implemented environment in which statutory documents are transformed from unstructured textual input into structured, time-aware, and emotion-adapted outputs. The disclosed embodiments specify concrete data structures, processing modules, and algorithmic flows that improve how the computer system stores, retrieves, and communicates legal information, thereby providing a technical improvement over conventional general-purpose text processing systems.

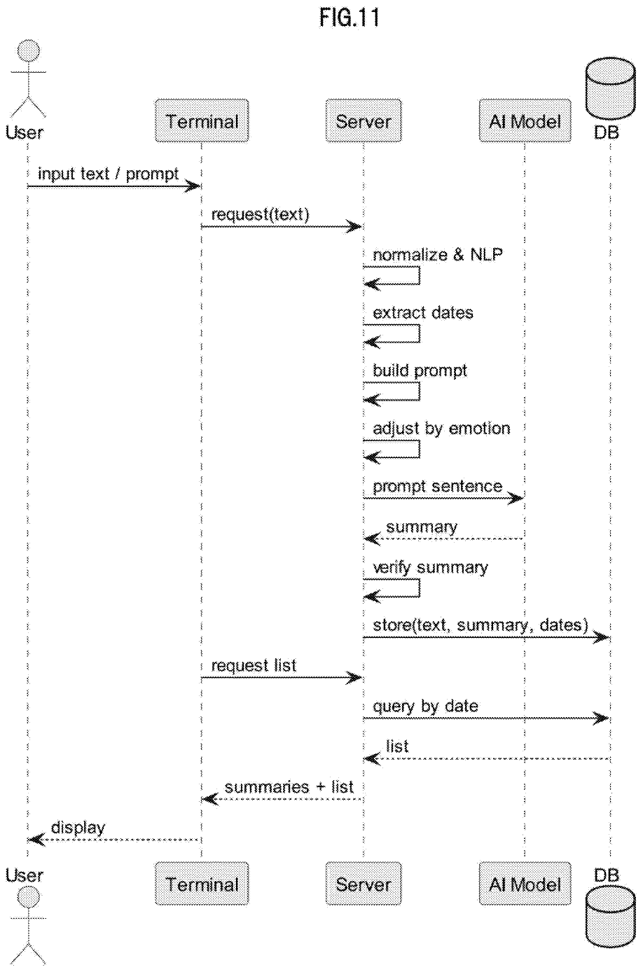

The following describes the processing flow using FIG. 11.

### Step 1:

The user inputs a statutory document or a prompt sentence.

The user operates the terminal and types or pastes statutory text and, optionally, a free-form prompt sentence into an input field. The terminal receives this text as character data and may attach simple metadata such as a mode flag (for example, “summarize” or “list_by_date”). The terminal converts the user's keystrokes or paste operation into a text string and temporarily stores it in local memory. As output, the terminal produces a request message containing the text string and the metadata, ready to be transmitted to the server.

### Step 2:

The terminal sends the input data to the server.

The terminal uses a network interface to transmit the request message over a network connection to the server. As input, the terminal uses the locally stored text string and metadata. The terminal encapsulates this data into a network protocol message (for example, an HTTP request body) and sends it to a predefined server endpoint. As output, the terminal generates a network packet stream directed to the server, which carries the statutory document text and the user's prompt sentence, if any.

### Step 3:

The server receives and parses the request.

The server uses a network interface and a web server component to accept the incoming request from the terminal. As input, the server receives the network packet stream and reconstructs the request message. The server then parses the message to extract the statutory text, any user-provided prompt sentence, user identifiers, and operation mode flags. The server stores these extracted values in memory as structured variables. As output, the server produces internal data structures containing the raw text, metadata, and context required for subsequent processing.

### Step 4:

The server normalizes and pre-processes the statutory text.

The server takes as input the raw statutory text string. The server applies character-level normalization, including conversion of full-width numerals to half-width numerals, unification of whitespace, and standardization of punctuation. The server removes or replaces control characters and non-printable symbols to avoid errors in later processing. The server may also detect the language of the text and select an appropriate NLP model configuration. As output, the server produces a cleaned and normalized text string that serves as a reliable basis for syntactic analysis.

### Step 5:

The server performs syntactic analysis using a natural language processing technique.

The server uses the normalized text string as input and runs an NLP library (such as a syntactic parser and a named entity recognizer) to analyze the structure of the statutory document. The server tokenizes the text into tokens, assigns part-of-speech tags, constructs a dependency parse tree, and identifies named entities such as dates, organizations, and articles. The server stores token indices, dependency relations, and entity spans in memory as structured representations. As output, the server generates a syntactic analysis result, including a parse tree and a list of linguistic elements, which will be used for date extraction and prompt sentence construction.

### Step 6:

The server extracts and normalizes date expressions and deadline information.

The server takes as input the syntactic analysis result and the list of named entities. The server scans the entities and surrounding tokens to detect date expressions and phrases indicating enforcement, application deadlines, and expiration. The server applies rule-based matching to era-based date formats and converts them into absolute calendar dates by referencing a mapping from era names to Gregorian years. The server classifies each normalized date as an enforcement date, application deadline, or expiration date by examining linguistic cues in the dependency tree (for example, verbs such as “come into force” or “lose effect”). As output, the server produces structured deadline information, such as a dictionary or record containing normalized dates and their semantic categories.

### Step 7:

The server generates an internal prompt sentence for the generative AI model.

The server uses as input the normalized statutory text, the syntactic analysis result, the structured deadline information, and any user-provided prompt sentence. The server composes a new prompt sentence that may embed the statutory text, specify output constraints (for example, “no more than five sentences”), and explicitly instruct the generative AI model to focus on enforcement and expiration dates. The server may incorporate hints derived from the analysis, such as a candidate enforcement date, into the prompt sentence. The server concatenates these components into a single textual instruction. As output, the server produces a finalized prompt sentence string that is ready to be sent to the generative AI model.

### Step 8:

The server adjusts the prompt sentence based on the user's emotional state.

The server takes as input the current prompt sentence and an estimated emotional state of the user, which may be derived from prior interaction data or signals provided by the terminal. The server applies an emotion processing mechanism to determine whether the user requires simpler language, more technical detail, or a particular tone. Based on this determination, the server modifies the wording of the prompt sentence (for example, adding “use very simple language and provide one example” or “preserve technical legal terms”). As output, the server produces an emotion-adjusted prompt sentence that tailors the generative AI model's behavior to the user's condition.

### Step 9:

The server sends the prompt sentence to the generative AI model and receives a summary result.

The server uses the emotion-adjusted prompt sentence as input and transmits it to a generative AI model endpoint over a network interface. The generative AI model processes the prompt and returns generated text that summarizes the statutory document and states key dates. The server receives the model's output text and parses it into a summary section and, if present, explicitly stated dates or bullet points. As output, the server obtains a summary result string and possibly additional structured elements (such as date lines) that will be integrated with the previously extracted deadline information.

### Step 10:

The server verifies and refines the summary result.

The server takes as input the summary result from the generative AI model and the structured deadline information extracted earlier. The server runs lightweight NLP or pattern matching on the summary result to detect date expressions and compare them with the normalized dates. If inconsistencies are found, the server may correct date formats or, in some configurations, generate a follow-up prompt sentence to request clarification from the generative AI model. The server restructures the summary result to align with the internal schema, such as ensuring that each key point and its associated date are clearly separable. As output, the server produces a validated and schema-compatible summary result that can be safely stored and displayed.

### Step 11:

The server stores the statutory document, summary result, and deadline information.

The server uses as input the raw statutory text, the validated summary result, and the structured deadline information. The server constructs database records containing these elements and executes write operations against a relational or similar database. The server assigns a unique identifier to the statutory document and stores normalized dates in dedicated date-type fields. The server also records timestamps and, optionally, an emotion profile for the user or session. As output, the server updates the persistent data storage so that the statutory document and its associated summary and deadlines are available for later retrieval and chronological listing.

### Step 12:

The server generates a time-ordered list of statutory summaries upon request.

The server takes as input a list request from the terminal, which may be expressed by a user prompt such as “list statutes in order of the closest enforcement date.” The server interprets the request and formulates a database query that orders records by enforcement_date, application_deadline, or expiration_date. The server executes the query and retrieves a subset of records containing summaries and date fields. The server then formats these records into a list structure, including only the fields necessary for display (for example, summary text and main dates). As output, the server produces a time-ordered list of statutory summaries suitable for transmission to the terminal.

### Step 13:

The server sends the summary result and time-ordered list to the terminal.

The server takes as input the validated summary result, the time-ordered list (if requested), and any additional display-related metadata. The server packages this information into a response message. The server may apply pagination or compression to reduce the data size. The server transmits the response message over the network interface back to the terminal. As output, the server generates a network packet stream that carries the summary result, the associated dates, and the time-ordered list to the terminal.

### Step 14:

The terminal renders the summary result and lists to the user.

The terminal uses as input the response message from the server. The terminal parses the message, extracts the summary result and list items, and updates the user interface. The terminal displays each summary along with its normalized dates, typically sorted so that statutes with the nearest enforcement or expiration dates appear first. The terminal may provide controls that allow the user to scroll, expand, or filter the displayed items. As output, the terminal presents visual representations of the processed statutory information on a display device, making the results accessible for user review.

### Step 15:

The user reviews the results and issues follow-up prompt sentences.

The user views the summaries and lists on the terminal display and evaluates whether the information is sufficient or understandable. Based on this evaluation, the user may input follow-up prompt sentences such as “Please simplify this summary further,” “Please provide an example for this provision,” or “Compare the enforcement dates of these two statutes.” The terminal accepts these new prompt sentences as input and repeats the transmission to the server. As output, the user initiates new requests that cause the server to generate additional or refined summary results using the same underlying processing flow.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented techniques for managing legal compliance information typically rely on simple keyword search, static rule sets, or manually curated summaries. Such techniques merely retrieve text passages of statutes and do not adequately interpret complex sentence structures, nested clauses, or context-dependent deadline provisions. As a result, conventional systems are unable to reliably extract and normalize enforcement dates, application deadlines, and transitional period deadlines in a manner that can be automatically integrated into time management functions executed by a computer system.

Furthermore, conventional systems treat natural language understanding and scheduling as separate subsystems. A text analysis engine may provide an unstructured summary, but a separate scheduling application requires manual input of dates and descriptions. This separation introduces redundant data entry, inconsistency between statute texts and registered deadlines, and delays in reflecting statutory amendments in calendar data. Consequently, the overall computer system behaves as a loosely coupled collection of tools rather than as an integrated compliance-management platform, leading to increased latency, higher error rates in deadline registration, and reduced reliability of notifications generated by the computer system.

In addition, existing approaches to generating summaries of statutes using generative models do not exploit the full capability of the underlying computing infrastructure. For example, generative models are often invoked on raw statute text without a structured pre-processing pipeline on the server side. This causes unnecessary token load, redundant processing, and unstable summary quality, and it fails to produce machine-usable structures that can directly drive time-based processes such as event creation and job scheduling. The computer thereby expends significant computing resources on generating free-form text that still requires human intervention for downstream processing, undermining the efficiency and determinism of the system.

Another problem is that conventional systems treat user interaction merely as input and output, without considering the user's emotional state or cognitive load. Fixed-style summaries and static notification patterns can overwhelm users in stressful compliance situations, or, conversely, may provide insufficient detail when users require more context. This lack of adaptivity prevents the computer from optimizing the format, granularity, and timing of its outputs, which results in suboptimal utilization of display resources, notification channels, and generative model calls, and diminishes the effectiveness of automated compliance support.

Moreover, when statutes are amended, conventional computer systems lack robust mechanisms to automatically compare pre-amendment and post-amendment provisions at scale. These systems typically lack a pipeline that uses both deterministic natural language processing and generative models to compute difference information and to propagate such difference information into existing calendar entries. As a consequence, calendar data becomes stale, and automated notifications may mislead users by reflecting outdated legal requirements. This indicates that the internal data structures and control logic of the computer system are not designed to maintain consistency between legal texts and schedule information in a dynamic legal environment.

Accordingly, there is a need for an improved computer-implemented system that tightly integrates natural language processing, generative model processing, structured deadline extraction, calendar registration, and notification scheduling. Such a system should transform unstructured statute text into structured, machine-usable representations that can be used to automatically configure time-based processes on the server. The system should further adapt the content and style of summaries using user-specific signals such as emotion state, thereby improving the efficiency, reliability, and usability of the underlying computer technology itself, rather than merely automating a mental or organizational process performed by humans.

The specific processing by the specific processing unit 290 of the data processing device 12 in Application Example 1 is realized by the following means.

The present invention provides a server comprising a processor configured to analyze statute text using a natural language processing pipeline to generate normalized document structure information and deadline candidate information, to construct and transmit a prompt sentence and context to a generative information processing model so as to obtain statute summary information and statute deadline information in a structured form, to synthesize a unified deadline information list including enforcement dates, application deadlines, and transitional period deadlines, to automatically register schedule information corresponding to each deadline in a time management module or an external schedule management service, to schedule and dispatch notification messages to a terminal device based on the registered schedule information, and to estimate a user emotion state and dynamically adjust the prompt sentence and summary parameters so as to adaptively control a presentation format and detail level of the statute summary information. This enables the computer system to transform unstructured legal text into machine-usable schedule data in an end-to-end automated manner, to maintain consistency between statute content and calendar entries across amendments, to reduce computational overhead and user input operations associated with manual deadline management, and to improve the technical performance of the server in terms of information extraction accuracy, scheduling reliability, and adaptive user interface behavior.
The term “statute text” refers to a text string or document that includes provisions of laws, regulations, ordinances, or similar normative documents expressed in natural language.
The term “natural language processing technique” refers to a sequence of computer-executed operations for processing natural language text, including at least one of tokenization, part-of-speech tagging, syntactic parsing, named-entity recognition, co-reference resolution, and normalization of expressions.
The term “document structure information” refers to machine-readable data indicating a structural organization of a statute text, including at least article-unit information, paragraph-unit information, item-unit information, or relationships between such units.
The term “deadline candidate information” refers to machine-readable data representing text portions or entities in a statute text that potentially indicate a time point or time period, such as enforcement dates, application deadlines, or transitional period deadlines, prior to final normalization or confirmation.
The term “generative information processing model” refers to a parameterized machine learning model that receives a prompt sentence and context information as input and generates natural language text and/or structured data as output, including a generative AI model implemented as a neural network.
The term “prompt sentence” refers to a natural language instruction or query, optionally combined with structured parameters, provided to a generative information processing model to specify a requested processing, such as summary generation, information extraction, or comparison of statute versions.
The term “statute summary information” refers to machine-readable data representing a condensed description of the content of a statute text, generated from the statute text and optionally from a response of a generative information processing model.
The term “statute deadline information” refers to machine-readable data representing one or more time points or time periods derived from a statute text, including at least enforcement date information, application deadline information, and transitional period deadline information.
The term “deadline information list” refers to a collection of statute deadline information elements organized in a machine-readable list structure, each element including at least a date or period, a type of deadline, and an associated description.
The term “enforcement date information” refers to statute deadline information indicating a time point at which a statute, or a part of a statute, becomes legally effective.
The term “application deadline information” refers to statute deadline information indicating a time point or time period by which a specified act, filing, registration, or other legally required operation must be completed.
The term “transitional period deadline information” refers to statute deadline information indicating a time point or time period during which a transitional or grace condition applies between an old legal regime and a new legal regime.
The term “schedule information” refers to machine-readable data representing an event or task to be managed by a time management module or an external schedule management service, including at least a title, a date or time, and an optional description.
The term “time management device” refers to a hardware and software configuration, implemented on a server or another computing apparatus, that maintains and manages schedule information, calendar events, reminders, and associated notification data.
The term “external schedule management service” refers to a network-accessible service executed on one or more remote computer systems that stores and manages schedule information, calendar events, and reminders and that provides an application programming interface for event registration and retrieval.
The term “communication device” refers to a hardware and software interface for transmitting and receiving data between a server and a terminal device over a communication network, including at least one of a network interface controller, a modem, and corresponding protocol stacks.
The term “terminal device” refers to a computing apparatus operated by a user, such as a smartphone, a tablet computer, or a personal computer, that is configured to communicate with a server, present information to the user, and accept user input.
The term “notification information” refers to machine-readable data specifying a message, timing, and display attributes for informing a user about a deadline, event, or change in statute-related schedule information.
The term “emotion state” refers to a classification or parameterization of a user's emotional condition, inferred from interaction data or other signals, such as stress level, confusion, urgency, or confidence, represented in a form usable by a computer system.
The term “emotion recognition process” refers to a sequence of computer-executed operations that estimate a user's emotion state from one or more inputs, such as interaction patterns, textual expressions, or sensor data, using heuristic rules or machine learning techniques.
The term “presentation format” refers to a layout or style of visual or audio output generated by a computer system, including at least a length of a summary, a degree of technicality, a structural organization, and emphasis indicators.
The term “detail level” refers to a granularity of information included in an output generated by a computer system, including at least an amount of explanatory content, citation density, and inclusion or omission of subordinate clauses and examples.
The term “normalized document structure information” refers to document structure information that has been processed to standardize character types, punctuation, and structural markers so that the information can be consistently interpreted and manipulated by a computer system.
The term “structured form” refers to a format in which information is encoded using defined fields, tags, or data types, such as key-value pairs, lists, or hierarchical records, suitable for direct processing by a computer program.
The term “existing statute information” refers to machine-readable data representing content and metadata of a statute or statutory provision before an update, amendment, or revision.
The term “updated statute information” refers to machine-readable data representing content and metadata of a statute or statutory provision after an update, amendment, or revision.
The term “obligation information” refers to machine-readable data describing a required action, prohibition, or duty imposed by a statute, including an identification of a regulated party, an action type, and optionally an associated deadline.
The term “request content” refers to information indicating a user's intention or required operation, contained in a prompt sentence or another user input, and interpreted by the server to configure processing of a generative information processing model.

In one embodiment, a server executes a program on a general-purpose computer system including at least one central processing unit (CPU), a main memory, a non-volatile storage device, and a network interface. The server runs an operating system such as a UNIX-compatible operating system and application software including a web application framework, a natural language processing library, and a generative AI client library. The server stores statute text, intermediate analysis results, and schedule information in a relational database management system, and the server communicates with at least one terminal via a wide-area network.

The server uses a natural language processing library such as a statistical or neural pipeline equivalent to spaCy to process statute text. The server loads a language-specific model that includes tokenization rules, a part-of-speech tagger, a dependency parser, and a named-entity recognition (NER) component. The server represents the statute text as a sequence of tokens and assigns each token a part-of-speech tag and a dependency relation. The server also assigns entity labels such as date expressions, article identifiers, organization names, and legal references. The server normalizes full-width and half-width characters, converts various date notations to a canonical internal representation, and resolves nested parentheses and multi-level list structures. By using this combination of operations, the server generates normalized document structure information and deadline candidate information that are stored in a structured data format such as tables or record objects.

The server generates document structure information by identifying article-unit segments, paragraph-unit segments, and item-unit segments. The server applies pattern-matching rules defined as regular expressions and dictionary lookups to tokens and dependency trees output by the natural language processing library. For example, the server detects patterns corresponding to “Article X,” “Paragraph Y,” and “Item (i)” and associates offsets in the statute text with these structural tags. The server stores this information in a table that maps article identifiers to text ranges and hierarchical relationships (e.g., article, paragraph, item). This internal representation allows the server to perform indexed retrieval of specific provisions with reduced computational overhead compared to scanning the entire text each time.

The server detects deadline candidate information by applying sequence patterns to the output of the named-entity recognition component. The server uses rule sets that combine entity types (DATE, TIME) with keyword patterns such as “enforcement,” “effective,” “shall apply from,” and “shall be completed by.” The server converts kanji numerals and other non-standard numeric expressions into integer values by using a numeric normalization module, and the server computes absolute dates from relative expressions by using a time arithmetic library equivalent to a datetime utility. The server stores deadline candidate information as records containing a raw text span, a normalized date value, a reference to the corresponding article or paragraph, and a confidence score computed from rule matching weights.

The server interfaces with a generative AI model that is implemented, for example, as a transformer-based neural network. The server may use a generative AI model hosted on an external computation service or a locally deployed generative AI model. The generative AI model is trained using a sequence-to-sequence learning objective on a corpus of legal and general-domain texts. The model architecture includes multiple self-attention layers, feed-forward layers, layer normalization, and positional encodings. The model parameters are optimized during training by minimizing a cross-entropy loss between predicted tokens and reference tokens, using gradient-based optimization such as Adam. The generative AI model encodes an input prompt sentence and associated context and then decodes a sequence of output tokens representing a summary and structured description of deadlines.

The server constructs an input for the generative AI model by concatenating the user-provided prompt sentence with the normalized statute segments and with extracted deadline candidate information. The server arranges this data using a predefined textual layout, such as a heading section for user instructions, a section listing the relevant articles and paragraphs, and a section listing candidate dates. The server thereby guides the generative AI model to focus on specific parts of the statute text and to generate outputs in a form that can be parsed programmatically. The server may, for example, include instructions such as “Output a concise summary of the statute and list each deadline with its type and date.”

The server uses various prompt sentences depending on the task. For example, the user may input the following prompt sentence through the terminal: “Please tell me the enforcement date of the Data Protection Act, summarize the main obligations, and add all relevant deadlines to my calendar.” In another example, the user may input: “From the attached labor standards law amendment, extract all compliance deadlines for employers within the next two years, summarize each requirement in plain English, and schedule reminders one month in advance.” The server embeds these prompt sentences into a broader context that also reflects the current state of the database and existing schedule entries.

The server receives the output of the generative AI model as a sequence of tokens forming natural language sentences and optionally embedded structured markers. The server applies a post-processing module that scans the output for marked segments indicating a list of deadlines, each including a deadline type, a date, and a brief description. The server validates the dates by comparing them with previously extracted deadline candidate information and resolves conflicts by applying deterministic rules, such as preferring dates that appear in both the natural language processing output and the generative AI output or requiring exact matching of article references. By performing this cross-validation, the server improves the precision of extracted deadlines and reduces false positives compared to relying solely on one method.

The server generates a unified deadline information list by merging records from the natural language processing stage and the generative AI stage. The server assigns each record a category, such as enforcement date, application deadline, or transitional period deadline. The server stores the unified list in a table that can be indexed by statute identifier, deadline type, and date value. This specific data structure allows the server to execute range queries to efficiently obtain upcoming deadlines for notification scheduling. As a result, the server reduces both the number of database scans and the amount of network traffic required to communicate deadline information to terminals.

The server registers schedule information corresponding to the deadline information list in a time management module or an external schedule management service. The server creates event objects that include a title generated from the statute summary information, a start date and end date derived from the normalized deadline, and a description based on the obligation text. The server may integrate with an external schedule management service through an application programming interface that requires authentication and structured event creation messages. The server maps internal identifiers, such as statute IDs and article IDs, to external event IDs so that the server can later update or delete specific calendar entries when statutes are amended.

The server schedules notifications by using a job scheduling subsystem implemented in software such as a distributed task queue. The server computes trigger times based on configured reminder offsets, such as 30 days or 7 days before each deadline. The server enqueues notification tasks with payloads that reference the event identifiers and contain a summary snippet. At the scheduled time, the server transmits notification information to terminals via push notification infrastructure. This scheduling mechanism reduces the need for terminals to perform continuous polling and lowers overall network load, since the server transmits notifications only at defined times.

The terminal is implemented, for example, as a smartphone, tablet, or personal computer that includes a processor, a memory, a display, input devices, and a network interface. The terminal executes a client application or web browser that communicates with the server using secure communication protocols. The terminal displays statute summary information, the deadline information list, and notification details. The terminal also captures user input, such as edits to reminder times or confirmations to register suggested events, and transmits such input to the server. By offloading heavy language processing and schedule computation to the server, the terminal can remain lightweight while still providing responsive user interaction.

The user interacts with the system by providing statute text, selecting statutes from a repository, or issuing prompt sentences that request specific analyses. The user may paste the full text of a statute into an input field on the terminal or upload a file containing statutory provisions. The user may also select a previously stored statute in the server database and input a prompt sentence specifying the type of analysis or comparison desired. The user can review the generated statute summary information, inspect individual deadlines in the deadline information list, and adjust or confirm schedule entries. This interactive behavior allows the server to refine the prompt sentences and summary parameters for subsequent calls to the generative AI model based on user preferences.

The server estimates a user emotion state by analyzing interaction patterns and text-based feedback. The server may, for example, compute features such as frequency of help requests, time taken to read summaries, and corrections to suggested deadlines. The server may also analyze short user comments provided through feedback fields by using a sentiment analysis model that maps text to a continuous stress or confusion score. The server aggregates such features into an emotion state representation. The server then modifies the prompt sentences and summary parameters, such as length constraints and technical vocabulary level, to adapt the presentation format and detail level. For example, if the emotion state indicates confusion, the server requests the generative AI model to provide longer, more explanatory summaries with more explicit references to article numbers. This dynamic adaptation reduces repeated requests, shortens the time required to comprehend the statute, and improves overall communication efficiency between the server and the terminal.

The server in some embodiments uses a locally hosted generative AI model. In such a configuration, the server stores the model parameters in the non-volatile storage device and loads them into memory at startup. The server then applies the model to input prompt sentences and context data without transmitting statute text to an external service. The server implements the generative AI model as a multi-layer transformer network, where each layer includes multi-head self-attention, residual connections, and feed-forward sublayers. The server uses a learned vocabulary and subword segmentation to represent tokens. During inference, the server executes matrix multiplications and non-linear activation functions optimized for the server's hardware, potentially leveraging vectorized instructions or specialized accelerators. By performing inference locally, the server reduces network latency and avoids external bottlenecks, thereby improving response time and stability.

The server trains or fine-tunes the generative AI model on a training dataset that includes pairs of statute text and desired summaries, as well as pairs of statute text and structured deadline annotations. The server minimizes a composite loss function that combines a token-level cross-entropy term for summary generation and a sequence-level term that encourages correct prediction of deadline types and normalized dates. The server updates model weights using stochastic gradient descent with adaptive learning rate scheduling and regularization methods such as dropout. When fine-tuning, the server may employ data augmentation strategies, such as paraphrasing legal sentences, masking dates, or shuffling clause order, to increase robustness. As a result, the generative AI model produces outputs that are better aligned with the internal structural representations used by the server.

The server improves computational efficiency relative to conventional systems by executing the natural language processing pipeline and generative AI model in a coordinated manner. By pre-reducing the statute text to key segments and candidate deadlines before invoking the generative AI model, the server reduces the number of tokens processed by the model. This reduction leads to lower computational cost and faster response times. The server also caches intermediate results, such as the normalized document structure information, so that subsequent queries against the same statute can reuse this information. Additionally, the structured representation of deadlines and article relationships allows the server to avoid repeated large-text parsing when scheduling notifications or updating calendar entries.

The server improves accuracy and robustness by cross-validating results of rule-based natural language processing and neural generative modeling. The server compares deadlines identified by rule-based extraction with those described in the generative AI model's output. When discrepancies occur, the server applies deterministic resolution strategies that take into account factors such as article references and frequency of occurrence in the text. This hybrid approach reduces both false positives and false negatives in deadline extraction. In contrast, relying exclusively on human manual reading or on a single type of automated technique tends to produce inconsistent and less reproducible results.

The server controls hardware resources and network communication in a manner that yields practical technical effects. For example, by aggregating notifications for multiple deadlines associated with the same statute into a single communication batch, the server reduces the number of network messages sent to each terminal. The server may also adapt the frequency and granularity of updates to the terminal based on the number of upcoming deadlines and the user's historical interaction pattern. This dynamic scheduling of communication reduces bandwidth usage and power consumption on both server and terminal devices, particularly on battery-powered terminals.

The server can be implemented in various alternative embodiments. In one alternative embodiment, the server uses a different natural language processing library that employs a recurrent neural network rather than a transformer-based parser, while preserving the same overall functional partitioning. In another embodiment, the server represents document structure information as a graph data structure stored in a graph database, enabling efficient traversal of cross-references between articles and annexes. In yet another embodiment, the server extends the emotion recognition process to incorporate physiological signals or voice tone measurements received from sensors connected to the terminal, using additional machine learning models trained for multimodal emotion estimation. These variations all maintain the central idea of combining structured natural language analysis, generative AI processing, and schedule management in a way that improves the technical functioning of the computer system.

The terminal may be implemented in different forms while still interacting with the server as described above. For example, a terminal may be a desktop computer displaying statute summaries in a web browser, or a mobile device running a native application that integrates with a local calendar application. The terminal in each case receives notification information from the server and uses operating system APIs to present alerts and to store local copies of schedule entries. The terminal thus leverages existing device-level notification and calendar mechanisms while delegating complex language and schedule analysis to the server.

The user in various uses of the system may manage different classes of statutes and regulations, such as data protection statutes, tax laws, or labor regulations. Regardless of the content domain, the server consistently applies the same processing pipeline: natural language processing to structure the statute text, generative AI processing guided by prompt sentences to generate summaries and detailed deadline information, and schedule registration and notification to create actionable, time-based reminders. Because the server is configured to translate unstructured statute text into structured schedule data and to manage differences across statute versions, the system as a whole provides improvements in processing speed, extraction accuracy, data consistency, and communication efficiency that go beyond mere automation of human reading and calendaring activities.

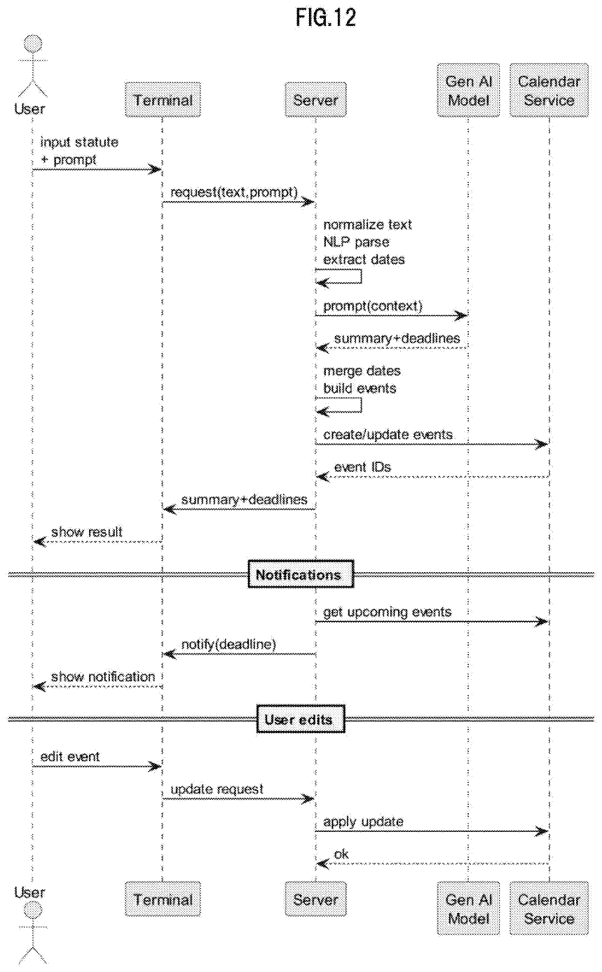

The following describes the processing flow using FIG. 12.

### Step 1:

The user provides a statute text and a prompt sentence to the terminal. The user inputs the statute text by pasting, typing, or uploading a file, and the user enters a prompt sentence such as “Please tell me the enforcement date of the Data Protection Act, summarize the main obligations, and add all relevant deadlines to my calendar.” The terminal bundles the statute text and the prompt sentence into a request object and sends the request to the server via a secure communication protocol. The input to this step is human-readable text data, and the output is a structured network request containing the statute text and the prompt sentence.

### Step 2:

The server receives the request object from the terminal and validates the payload. The server checks that the statute text field is present, that the prompt sentence is present, and that the user authentication token is valid. The server then converts the statute text to a unified character encoding (for example, UTF-8) and performs Unicode normalization to standardize character forms. Based on the input request, the server outputs a cleaned and normalized statute text string and an associated user context record for further processing.

### Step 3:

The server applies a natural language processing pipeline to the normalized statute text. The server loads a language model and performs tokenization, part-of-speech tagging, dependency parsing, and named-entity recognition. Using the parsed structure as input, the server identifies document units such as articles, paragraphs, and items by applying pattern rules to token sequences and dependency relations. The output of this step is document structure information that maps each identified unit to a span in the statute text and stores unit types and hierarchical relationships.

### Step 4:

The server extracts deadline candidate information from the parsed statute text. The server uses the named-entity recognition output and rule-based patterns to detect date expressions and deadline-related phrases, such as enforcement dates and application deadlines. The input to this step is the annotated text produced by the natural language processing pipeline, and the server converts non-standard date formats into normalized date values. The output is a set of deadline candidate records, each containing a text span, a normalized date, an associated document unit, and a confidence value.

### Step 5:

The server generates a condensed context for the generative AI model by selecting relevant statute segments. The server analyzes document structure information and deadline candidate information to locate portions of the statute text that are likely to contain obligations, prohibitions, and deadlines. Based on this input, the server aggregates selected segments into a reduced text context that includes only critical provisions. The output of this step is a compact context text and a metadata list that reference the original statute locations.

### Step 6:

The server constructs a model-specific prompt by combining the user's prompt sentence with the condensed context and deadline candidates. The server arranges these inputs into a textual layout that includes an instruction section, a statute excerpt section, and a list of candidate dates. The server adds explicit instructions to request statute summary information and statute deadline information in a structured style. The output is a complete prompt string ready to be submitted to the generative AI model.

### Step 7:

The server sends the constructed prompt to the generative AI model and requests generation of output. The server passes the prompt string as input to a transformer-based generative model endpoint, specifying parameters such as maximum token length and sampling configuration. The generative AI model processes the prompt and returns a sequence of tokens forming summary sentences and deadline descriptions. The server receives this response as text output and optionally as machine-readable markers embedded in the text.

### Step 8:

The server post-processes the generative AI model output to extract structured statute summary information and statute deadline information. The server parses the returned text, using pattern matching and simple grammars to identify summary paragraphs and enumerated deadlines. The input to this step is the raw text produced by the generative AI model, and the server generates structured records that represent summary items, deadline types, normalized dates, and brief explanations. The output is a set of structured summary elements and structured deadline elements.

### Step 9:

The server merges the structured deadline elements from the generative AI output with the deadline candidate information from the natural language processing step. The server compares dates, article references, and descriptions to detect duplicates and resolve conflicts. Using both sets of information as input, the server applies deterministic rules to accept or reject candidates and to choose a preferred normalized value for each deadline. The output is a unified deadline information list, in which each entry includes a deadline category, a final normalized date, a reference to the statute unit, and a short description.

### Step 10:

The server creates schedule information corresponding to each entry in the unified deadline information list. The server generates event objects by assigning titles derived from the statute summary information, setting start and end dates based on the normalized dates, and composing descriptions from the associated obligations. The input to this step is the unified deadline list and the statute summary information, and the output is a set of event records formatted for a time management module or an external schedule management service.

### Step 11:

The server registers the event records in a calendar or scheduling system. The server transmits the event records to an internal time management module or calls an external schedule management service through an application programming interface. The server receives confirmation or event identifiers from the target system. The input to this step is the event records created in the previous step, and the output is a mapping between internal identifiers and external calendar event identifiers, which is stored in the server's database.

### Step 12:

The server schedules notification tasks based on the registered event records. The server computes one or more reminder times for each event, such as a specified number of days before the deadline. Using the event dates and reminder offsets as input, the server enqueues jobs in a task scheduler, each job containing event identifiers and minimal notification payloads. The output of this step is a set of scheduled tasks, each associated with a future execution time.

### Step 13:

The server executes notification tasks at the scheduled times and sends notification information to the terminal. When a scheduled time is reached, the server retrieves the corresponding event record, composes a notification message that includes the event title, deadline date, and a short description, and transmits this message to the terminal using a push notification infrastructure. The input to this step is the scheduled task data and event records, and the output is a set of notification messages delivered to terminals.

### Step 14:

The terminal receives notification messages and presents them to the user. The terminal processes each incoming notification, maps it to a local representation of the associated event, and requests additional details from the server if needed. Based on this input, the terminal displays a visual alert, banner, or dialog that includes the deadline and the summarized obligation. The output is an on-screen notification that prompts the user to review or act on the upcoming deadline.

### Step 15:

The user reviews statute summary information and deadline entries on the terminal. The user opens the notification or a dedicated screen showing the statute summary and the deadline information list. The user may inspect individual deadline entries, including the related statute passages, and determine whether the automatically registered schedule information is appropriate. The input to this step is the information displayed by the terminal, and the output is a user decision to confirm, modify, or reject certain schedule entries.

### Step 16:

The terminal sends user modifications or confirmations back to the server. The user may adjust reminder times, change descriptions, or delete unwanted events, and the terminal records these changes as structured update requests. The input to this step is user interaction data, and the terminal outputs update requests that specify operations on particular event identifiers and deadline entries.

### Step 17:

The server updates schedule information and the deadline information list according to the user's modifications. The server applies the update requests to the internal database and, when necessary, propagates changes to the external schedule management service through its application programming interface. The input to this step is the user's update requests, and the output is revised event records and a revised deadline information list that remain synchronized with both the statute content and the user's preferences.

### Step 18:

The server estimates the user's emotion state using interaction logs and text feedback. The server gathers features such as frequency of clarification requests, editing patterns of schedule entries, and sentiment scores computed from free-form user comments. Using these features as input, the server computes an emotion state vector or category. The output is an internal representation of the user's emotion state that can be referenced in subsequent processing.

### Step 19:

The server adjusts future prompt sentences and summary parameters based on the estimated emotion state. The server modifies properties such as desired summary length, requested level of detail, and emphasis on examples or citations. The input to this step is the emotion state representation, and the output is updated configuration parameters and modified prompt constructions that will be embedded in subsequent calls to the generative AI model. As a result, the server can produce summaries that better match the user's comprehension needs in later interactions.

### Step 20:

The user initiates additional analysis by issuing a new prompt sentence through the terminal. The user may input, for example, “From the attached amendment to the Data Protection Act, extract only new or changed compliance deadlines, summarize the changes, and adjust the existing calendar entries.” The terminal sends this prompt sentence and, optionally, identifiers of related statutes to the server. The input to this step is the new user instruction, and the output is a new analysis request that triggers the same sequence of processing steps, now influenced by the previously adjusted prompt parameters and emotion-aware configuration.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented techniques for processing statute-like documents suffer from several technical limitations when applied to long, highly structured texts containing nested brackets, dense numerical expressions, and formal language. Traditional natural language processing pipelines typically apply rule-based parsing or shallow statistical models that are not robust to deeply nested syntactic structures and heterogeneous temporal expressions. As a result, a computing device frequently fails to extract, in a deterministic and machine-usable manner, critical elements such as obligation bearers, required actions, and associated deadlines.

Furthermore, known summarization mechanisms generally treat summarization as a purely text-reduction task and do not integrate a deadline-centric organization of the output. Even when a summary is produced, the computer system does not maintain an internal, structured representation of normalized deadline data. This prevents the system from efficiently classifying and sorting summaries according to actionable time limits, thereby limiting the ability of the system to present machine-generated summaries in a form that supports rapid retrieval and timeline-based navigation. Such limitations result in increased processing load on the user interface layer and require additional manual operations by an end user.

In addition, existing systems that invoke generative artificial intelligence models typically issue generic prompts that are not adapted to user-specific conditions or states. These systems do not incorporate an emotion-aware feedback loop into the summarization pipeline. Consequently, a computer is unable to dynamically adjust prompt sentences and summarization conditions in response to detected emotional states of users, such as confusion, anxiety, or overload. This lack of adaptive control over the generative model often leads to summaries that are either too technical or insufficiently detailed, causing repeated requests and redundant processing and thus reducing overall system efficiency.

Moreover, many document processing architectures do not tightly couple syntactic and semantic analysis modules with generative models and temporal normalization modules in an integrated processing flow. In such architectures, each component functions largely in isolation, resulting in suboptimal data exchange, redundant parsing, and inefficient resource usage on the processor. The absence of a unified control mechanism that orchestrates natural language parsing, generative summarization, deadline extraction, and emotion-based adjustment degrades both system responsiveness and quality of output.

Accordingly, there is a need for an improved computer-implemented system and method that (i) performs robust syntactic and semantic analysis of complex rule documents, (ii) cooperates with a generative artificial intelligence model via prompt sentences to obtain concise and accurate summaries, (iii) automatically extracts and normalizes deadline information and structures the summaries based on such deadlines, and (iv) adaptively adjusts prompting and summarization parameters in response to recognized user emotional states. Such improvements would enhance the internal operation of the computer system by reducing redundant processing, enabling more efficient information retrieval, and producing outputs that are automatically organized in a machine-optimizable structure suitable for deadline-centric presentation.

The specific processing by the specific processing unit 290 of the data processing device 12 in Example 2 is realized by the following means.

The present invention provides a server comprising a processor configured to analyze rule documents by performing syntactic and semantic analysis using a natural language processing technique, to generate structured analysis results including at least obligation information and temporal expressions, to input instruction information including a prompt sentence and the structured analysis results into a generative artificial intelligence model, to request generation of a summary from the generative artificial intelligence model, to extract important information from a generated summary, to extract deadline information from at least one of the generated summary and the rule documents, to normalize the deadline information into a standard machine-usable format using a date and time processing function, to classify and sort the generated summary based on the normalized deadline information so as to structure output data in a deadline-indexed format, to recognize an emotional state of a user using an emotion processing function, to adjust at least one of the prompt sentence and a summarization condition for the generative artificial intelligence model according to the emotional state so as to modify a summarization manner, and to receive, via a communication interface, the rule documents and the prompt sentence from a terminal and to transmit the structured output data to the terminal. This enables an improvement in computer technology by integrating natural language parsing, emotion-aware control of a generative artificial intelligence model, and automatic deadline normalization into a unified processing pipeline, thereby allowing the server to internally generate concise and accurate summaries of complex rule documents, automatically organize the summaries according to normalized deadline information, adapt summarization behavior based on user emotional state, and reduce user interaction steps and processing redundancy while enhancing the efficiency and responsiveness of the overall document processing system.
The term “rule document” refers to a structured text document that defines binding rules, obligations, conditions, or procedures, including but not limited to statutes, regulations, policies, standards, and contractual clauses.
The term “natural language processing technique” refers to a computational technique by which a computer system processes, analyzes, and interprets human language text, including operations such as tokenization, part-of-speech tagging, syntactic parsing, semantic analysis, and entity recognition.
The term “syntactic analysis” refers to a process in which a computer system determines grammatical structures of text, including relationships among words and phrases, by using parsing algorithms or models to build representations such as parse trees or dependency graphs.
The term “semantic analysis” refers to a process in which a computer system determines meanings and contextual relationships of words, phrases, and sentences, including roles of entities, actions, and attributes, by using statistical models, embeddings, or other computational methods.
The term “generative information processing model” refers to a trained computational model, such as a neural network-based language model, that generates new text or data in response to input information, including but not limited to generative artificial intelligence models for natural language generation.
The term “generative artificial intelligence model” refers to a generative information processing model that uses artificial intelligence techniques, such as machine learning or deep learning, to produce text outputs, summaries, or other content based on input prompts and data.
The term “prompt sentence” refers to an input text instruction provided to the generative artificial intelligence model, specifying a desired processing operation, summarization style, output format, or level of detail.
The term “instruction information” refers to data supplied to the generative artificial intelligence model that includes at least one prompt sentence and one or more analysis results or text segments, and that guides the model in generating a corresponding output.
The term “summary” refers to a condensed text generated from one or more rule documents that preserves essential information, including at least key obligations, conditions, and relevant temporal information, in fewer words than the original text.
The term “important information” refers to content identified by the system as being central to understanding a rule document, including at least information about subjects, required actions, conditions, exemptions, and deadlines.
The term “deadline information” refers to temporal expressions contained in or derived from a rule document or a summary, including dates, times, periods, and recurring time limits that specify when an action must or should occur.
The term “date and time processing function” refers to a computational function or module that parses, validates, converts, or normalizes date and time expressions into a standardized, machine-usable representation.
The term “standard format” refers to a normalized, machine-readable representation of data, such as a calendar date or time expression encoded according to a consistent schema that allows programmatic comparison, sorting, indexing, and retrieval.
The term “classify and sort” refers to a process in which the system assigns items, such as summaries, to categories or groups based on one or more attributes and arranges the items in a particular order according to those attributes.
The term “output data” refers to data generated by the system for presentation or further processing, including at least deadline-indexed summaries, associated metadata, and structured records derived from rule documents.
The term “deadline-indexed format” refers to a data structure or layout in which summaries or related information are organized and arranged according to associated deadline information, enabling retrieval or display based on time criteria.
The term “user” refers to any person or entity that interacts with the system via a terminal to input rule documents or prompt sentences and to receive summaries or related information.
The term “emotional state” refers to a condition of a user inferred by the system, such as confusion, satisfaction, anxiety, overload, or interest level, which may be derived from user inputs, interaction patterns, or external sensors.
The term “emotion processing function” refers to a computational function or module that detects, estimates, or classifies a user's emotional state and outputs corresponding control signals or parameters to influence system behavior.
The term “summarization condition” refers to one or more parameters that control the operation of the generative artificial intelligence model when generating a summary, including but not limited to target length, level of technical detail, tone, language style, and focus of content.
The term “summarization manner” refers to a mode or style in which a summary is generated, determined at least in part by summarization conditions and prompt sentences, and affecting aspects such as complexity, detail, structure, and emphasis.
The term “terminal” refers to an information processing device operated by a user, such as a computing device, communication device, or display device, that can send rule documents and prompt sentences to the server and receive output data from the server.
The term “communication function” refers to hardware, software, or a combination thereof that enables data exchange between the server and at least one terminal over a communication network using one or more communication protocols.
The term “communication interface” refers to a logical or physical interface of the server that supports sending and receiving data via the communication function, including network adapters, communication ports, and protocol stacks.
The term “professional worker” refers to a human operator having specialized knowledge related to rule documents, such as a legal practitioner, compliance officer, or subject-matter expert, who can manually interpret and explain such documents.
The term “information retrieval apparatus” refers to a computing system that stores and retrieves text information in response to a query, such as a search engine, database system, or document management system.
The term “list format” refers to a presentation style in which multiple summaries or items are arranged as discrete entries in an ordered or unordered list, table, or comparable structured visual or data format.

In one embodiment, the system includes a server, at least one terminal, and a communication network connecting the server and the terminal. The server includes a processor, a memory, a non-volatile storage device, and a network interface. The terminal includes a processor, a display unit, an input unit such as a keyboard or touch panel, and a communication interface. The server and the terminal execute software modules stored in their respective memories to realize the functions described below.

The server executes an operating system such as a general-purpose server operating system and a runtime environment such as a scripting language runtime. The server loads a natural language processing library such as a syntactic and semantic analysis engine (for example, a library of the spaCy type) and a transformer-based language representation library (for example, a library of the Transformers type). The server also loads or accesses a generative AI model such as a transformer-based sequence-to-sequence model or autoregressive language model implemented as a neural network. The server further executes a date and time processing library, an emotion recognition module, and a web application framework.

The server uses the natural language processing library to perform tokenization, part-of-speech tagging, dependency parsing, and named entity recognition on a rule document. The server stores intermediate results in explicit data structures such as token lists, dependency graphs, and entity lists. The server uses an embedding module implemented via the transformer-based library to compute contextual vector representations for tokens and sentences. The server stores these embeddings in multidimensional arrays in memory.

The server uses a generative AI model implemented as a deep neural network to generate a summary. In one embodiment, the generative AI model is a transformer architecture having an encoder and a decoder, each composed of multiple attention layers and feed-forward layers. The server uses an attention mechanism with multi-head self-attention, where the model computes attention scores from query, key, and value vectors derived from the embeddings. The server stores model parameters such as weight matrices and bias vectors in the storage device and copies them into memory during execution.

The server trains the generative AI model in advance using a large corpus including rule documents and human-written summaries. The server uses supervised learning, where input sequences contain rule document segments, and output sequences contain target summaries. During training, the server computes a loss function such as cross-entropy between predicted tokens and target tokens. The server updates the weights of the transformer network using an optimization algorithm such as stochastic gradient descent with momentum or an adaptive method such as Adam. The server performs backpropagation by computing gradients through the attention layers and feed-forward layers. The server may use techniques such as dropout regularization, layer normalization, and positional encoding to improve generalization and convergence. After training, the server stores the final model parameters in the storage device.

The server uses an emotion processing function to adjust how the generative AI model is called. In one embodiment, the server obtains emotion-related features from user interactions, such as typing speed, frequency of help requests, click patterns, or explicit feedback texts. The server applies a classifier model, for example a shallow neural network or a support vector machine, to these features to determine an emotional state such as “confused,” “overwhelmed,” or “satisfied.” The server stores thresholds and decision boundaries for the classifier and uses them to output discrete emotion labels or continuous emotion scores.

The server modifies one or more summarization conditions based on the emotion label. For example, when the emotion state is “confused,” the server sets a lower target complexity and a higher maximum token count for the generative AI model, thereby producing a more detailed but simpler summary. When the emotion state is “overloaded,” the server sets a smaller maximum token count and instructs the generative AI model to emphasize only deadlines and required actions. The server encodes these conditions as control parameters such as temperature, top-k sampling threshold, maximum output length, and style tags in the prompt sentence. This adaptive adjustment differs from simple rule-based post-editing by changing the internal decoding behavior of the generative AI model through its sampling parameters and control tokens.

The terminal provides a user interface that allows the user to input a rule document and a prompt sentence. The user operates the terminal and opens a web page or application screen that contains a text input area for a rule document and a text input area for a prompt sentence. The user enters a rule document such as “According to Article 25, Paragraph 1 of the income tax law, salary earners must file income tax returns by December 31 of every year.” The user enters a prompt sentence such as “Summarize the following statute in no more than one sentence and clearly state who must do what by when.” The terminal displays these texts on the display unit and transmits them to the server via the communication interface.

The server receives the rule document and the prompt sentence. The server first normalizes the text by converting different character widths and unifying punctuation marks. The server then performs syntactic analysis using the natural language processing library. For example, the server identifies noun phrases such as “salary earners,” predicate phrases such as “must file income tax returns,” and temporal expressions such as “by December 31 of every year.” The server represents the syntactic structure using dependency trees and stores the structure in a graph data type.

The server performs semantic analysis to determine roles such as agent, action, object, and temporal constraint. The server uses contextual embeddings from a transformer-based representation model. The server uses these embeddings to compute similarity between phrases and pre-defined semantic roles. The server may apply a feed-forward neural network trained to output role labels given embedding vectors. The server then stores the final semantic roles in structured records containing fields such as “subject,” “obligation,” “condition,” and “deadline_expression.”

The server constructs an instruction text for the generative AI model by combining the user-provided prompt sentence with the structured analysis results. For example, the server generates an internal instruction such as:
“Instruction: Summarize the following statute in no more than one sentence and clearly state who must do what by when.
Subject: salary earner
Obligation: file income tax return
Deadline: by December 31 of every year
Law text: [original rule document text]
Output:”

The server passes this instruction text to the generative AI model as input. The server sets model parameters such as maximum decoding length and sampling temperature according to the emotion-based summarization conditions. The generative AI model generates a summary, for example “Salary earners must file an income tax return by December 31 each year.”

The server extracts deadline information from the generated summary and from the original rule document. The server applies pattern matching and a date-entity recognizer to identify temporal expressions. The server uses a date and time processing library to parse expressions such as “by December 31 of every year” into a normalized format such as an internal structure with fields for month, day, and periodicity. The server stores the normalized deadline in a time-indexed record, associating it with the summary and the source rule document.

The server organizes summaries in a deadline-indexed format. When multiple rule documents are processed, the server builds an array or list of records, each record containing at least a normalized deadline, a summary string, and a reference to a source rule document. The server sorts this array by the normalized deadline field. The server formats the records into a human-readable representation, such as “December 31: salary earners must file income tax returns.” The server returns the sorted summaries to the terminal as structured output data.

The terminal receives the structured output data and renders it as a list or table on the display. The terminal displays the deadline-indexed summaries in chronological order. The user views the list and can quickly identify upcoming obligations by date. The terminal may allow the user to select a summary to view the original rule document and the associated metadata. The user can also input an additional prompt sentence, for example “Explain this obligation in more detail for a non-expert, but keep it under three sentences.” The terminal sends this new prompt sentence, together with the reference to the selected rule document, to the server. The server repeats the processing, this time generating a multi-sentence explanation according to the new summarization conditions.

The server improves processing efficiency and accuracy compared to conventional systems in several ways. The server performs syntactic and semantic analysis once for each rule document and reuses the structured representation to guide multiple summarization requests. This reuse reduces redundant parsing operations and decreases CPU load. The server stores normalized deadlines and uses them as index keys, enabling faster retrieval and sorting than string-based operations. The server reduces communication load by transmitting compact summaries and structured deadline information instead of entire documents for each interaction.

The server improves summarization accuracy by integrating structured role labels and deadlines directly into the input of the generative AI model. This integration constrains the model to focus on critical roles and temporal constraints, reducing the risk of omitting or misrepresenting obligations. The server's emotion-based adjustment mechanism further improves user-specific accuracy by adapting the level of detail and complexity. For example, when users repeatedly request clarification, the server interprets this as confusion and adjusts the model parameters to generate simpler and longer explanations that explicitly restate key definitions and deadlines.

In another embodiment, the server uses a different type of generative AI model, such as a decoder-only transformer. In this case, the server encodes both the instruction and the rule document as a single token sequence and lets the model generate continuation tokens representing the summary. The server again uses internal parameters such as temperature, nucleus sampling thresholds, and length penalties to control output style. The server may fine-tune the decoder-only model on a specialized corpus of rule documents and deadline-focused summaries, using a similar loss function and optimization procedure as described above.

The server can also employ alternative natural language processing components. For example, instead of a single syntactic parser, the server may use an ensemble of parsers and combine their outputs using a voting or confidence-weighted strategy. The server may store multiple dependency graphs and select the most probable structure based on consistency with semantic role predictions. This redundancy improves robustness when encountering highly nested or atypical rule document structures.

The server can vary the emotion processing function according to available data. In one variation, the server obtains explicit user feedback through control elements on the terminal such as buttons indicating “too complex” or “too simple.” The server records these labels and updates the emotion classifier incrementally using online learning techniques. In another variation, the server uses language features from user-entered comments, such as presence of question marks, exclamation marks, or specific complaint keywords, as input features to the emotion classifier. These mechanisms allow the server to refine its emotion recognition over time, thereby continuously improving the quality of adapted summaries.

The system provides technical advantages over conventional manual processing. The server uses internal data structures such as dependency trees, semantic role tables, embedding matrices, and deadline-indexed arrays to reduce ambiguity and to enable efficient retrieval and sorting. The server's use of normalized deadlines and indexed summaries decreases search time complexity for time-based queries. The integrated pipeline that combines syntactic analysis, semantic analysis, generative summarization, deadline normalization, and emotion-based adaptation leads to improved resource utilization because intermediate results are shared and reused across components. This integrated architecture reduces the number of passes over the data and lowers overall latency.

The server thereby improves computer technology itself rather than merely automating a mental process. The server employs specialized neural architectures and structured data flows that allow the machine to handle highly nested, formal rule documents with greater speed and reduced error compared to a naive text-processing approach. The combination of structured linguistic analysis, controllable generative AI behavior, and machine-readable deadline indexing leads to a system that processes data in a way that a human could not efficiently replicate, particularly in terms of large-scale, real-time processing of numerous complex documents. The described embodiments are exemplary, and the server, the terminal, and the processing modules can be modified or extended without departing from the scope defined by the claims.

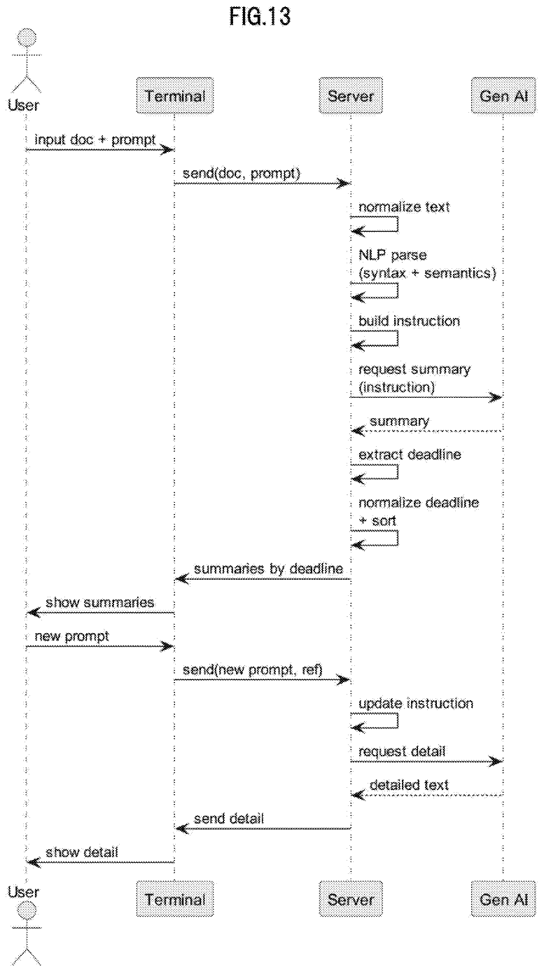

The following describes the processing flow using FIG. 13.

### Step 1:

The user operates the terminal and inputs a rule document and a prompt sentence.

The user types or pastes the rule document into a text input field on the terminal and then types a prompt sentence such as “Summarize the following statute in no more than one sentence and clearly state who must do what by when.” into a separate text input field.

The terminal receives, as input, the raw rule document text and the raw prompt sentence, and the terminal outputs a data payload including both texts stored in internal variables.

### Step 2:

The terminal prepares a transmission request to the server.

The terminal embeds the rule document and the prompt sentence into a structured message, for example assigning them to fields such as “document_text” and “prompt_text” in an internal data object.

The terminal sets a destination address of the server and configures communication parameters such as protocol and headers.

The terminal uses the input rule document and prompt sentence to generate, as output, a communication message ready to be sent to the server.

### Step 3:

The terminal sends the communication message to the server.

The terminal uses its communication interface to transmit the message over a network to the server, for example by opening a network connection and writing the message bytes to the connection.

The input to this step is the structured communication message, and the output is the arrival of the same data at the network interface of the server.

### Step 4:

The server receives and parses the communication message.

The server reads the message from its network interface and passes it to an application module.

The server extracts the rule document text and the prompt sentence from the message and stores them in memory as separate strings.

The input to this step is the raw communication message, and the output is a pair of internal text variables: one for the rule document and one for the prompt sentence.

### Step 5:

The server normalizes the rule document text and the prompt sentence.

The server converts character encodings if necessary, unifies punctuation marks, and converts variant character forms (for example, full-width digits to half-width digits).

The server removes unnecessary spaces and line breaks using string operations.

The input to this step is the unnormalized rule document and prompt sentence, and the output is a normalized rule document string and a normalized prompt sentence string suitable for language processing.

### Step 6:

The server performs syntactic analysis of the rule document.

The server inputs the normalized rule document string to a natural language processing module that performs tokenization, part-of-speech tagging, and dependency parsing.

The server generates a list of tokens, assigns a part-of-speech tag to each token, and constructs a dependency tree that represents grammatical relations between tokens.

The input to this step is the normalized rule document, and the output is a syntactic representation including a token list and a dependency structure.

### Step 7:

The server performs semantic analysis and role extraction.

The server uses a transformer-based representation model to compute contextual embeddings for the tokens and sentences of the rule document.

The server combines the embeddings with the dependency structure to determine semantic roles such as subject, action, object, and temporal expression.

The server stores these roles in a structured record with fields such as “subject,” “obligation,” “condition,” and “deadline_expression.”

The input to this step is the syntactic representation and the normalized rule document, and the output is a semantic record that describes core elements of the rule document.

### Step 8:

The server generates internal instruction text for a generative AI model.

The server combines the normalized prompt sentence with the semantic record and the original rule document into a single instruction text.

The server explicitly inserts the extracted subject, obligation, and deadline expression into the instruction to guide the generative AI model, for example by forming text such as “Subject: [subject], Obligation: [obligation], Deadline: [deadline_expression], Law text: [document].”

The input to this step is the normalized prompt sentence and the semantic record, and the output is a composed instruction text to be supplied to the generative AI model.

### Step 9:

The server determines summarization conditions based on an estimated emotional state.

The server retrieves previously stored emotion-related data for the user, such as prior feedback or interaction patterns, and optionally new signals from the current interaction.

The server applies an emotion processing function to classify the user's emotional state (for example, confused or overloaded).

The server maps the classified emotional state to summarization parameters such as maximum summary length, level of detail, and complexity level.

The input to this step is emotion-related feature data, and the output is a set of summarization condition parameters.

### Step 10:

The server configures the generative AI model according to the summarization conditions.

The server sets model parameters such as maximum output tokens, sampling temperature, and style indicators based on the summarization condition parameters.

The server prepares a model input structure that includes the instruction text and the configuration parameters.

The input to this step is the summarization condition set and the instruction text, and the output is a configured model input ready for summarization.

### Step 11:

The server invokes the generative AI model to generate a summary.

The server passes the configured model input to the generative AI model and starts a decoding process.

The generative AI model produces tokens one by one according to its internal neural network computations and the supplied parameters, and the server concatenates these tokens into a summary sentence or sentences.

The input to this step is the configured model input, and the output is a generated summary text representing the condensed rule document.

### Step 12:

The server validates and post-processes the generated summary.

The server checks whether the summary satisfies constraints such as maximum length and presence of a subject and a deadline expression.

The server may re-run a lightweight syntactic and semantic analysis on the summary to verify that an obligation and a deadline are both present.

The server removes redundant or repeated segments, adjusts formatting, and ensures the summary text is consistent with the original rule document's core information.

The input to this step is the raw summary text from the generative AI model, and the output is a refined summary text ready for deadline extraction.

### Step 13:

The server extracts deadline information from the summary and the rule document.

The server applies pattern matching and temporal entity recognition to the refined summary and, if necessary, to the original rule document to detect date or time expressions.

The server selects one or more expressions representing deadlines, such as “by December 31 of every year,” and associates them with the summary.

The input to this step is the refined summary and the rule document, and the output is a set of detected deadline expressions linked to the summary.

### Step 14:

The server normalizes the detected deadline expressions.

The server inputs each detected deadline expression to a date and time processing function that parses the expression and converts it into a standardized representation, for example a structure containing day, month, year (if applicable), and recurrence pattern.

The server stores the normalized deadlines in a time-indexed format suitable for sorting and comparison.

The input to this step is the set of raw deadline expressions, and the output is a set of normalized deadline records.

### Step 15:

The server constructs deadline-indexed summary records.

The server creates a record for each summary that includes at least the normalized deadline, the refined summary text, and a reference to the source rule document.

The server adds these records to a collection such as a list or array stored in memory or a database.

The input to this step is the refined summary and the normalized deadline records, and the output is a collection of structured summary records indexed by deadline.

### Step 16:

The server sorts and formats the summary records for presentation.

The server sorts the collection of summary records by the normalized deadline, for example from earliest to latest.

The server formats each record into a presentation string such as “December 31: salary earners must file income tax returns.”

The input to this step is the unsorted collection of structured summary records, and the output is an ordered list of formatted summary strings.

### Step 17:

The server generates response data for the terminal.

The server packages the ordered list of formatted summary strings and associated metadata into a response object.

The server adds any additional information needed by the terminal, such as identifiers for the source rule documents.

The input to this step is the ordered list of formatted summary strings, and the output is a structured response data unit.

### Step 18:

The server transmits the response data to the terminal.

The server uses its network interface to send the response data over the communication network back to the terminal.

The server may apply compression or encoding to reduce data size and ensure integrity.

The input to this step is the structured response data, and the output is the delivery of this data to the terminal's communication interface.

### Step 19:

The terminal receives and interprets the response data.

The terminal reads the response from its communication interface and parses the structured response object.

The terminal extracts the ordered list of formatted summary strings and any associated metadata and stores them in memory.

The input to this step is the raw response data from the server, and the output is an internal representation of the summaries and metadata ready for display.

### Step 20:

The terminal displays the deadline-indexed summaries to the user.

The terminal generates visual elements such as list items or table rows for each formatted summary string and renders them on the display unit.

The terminal arranges the items in chronological order according to the deadlines and may provide interactive controls for the user to select a particular summary.

The input to this step is the internal representation of the summaries, and the output is the visible presentation of the summaries on the terminal screen.

### Step 21:

The user reviews the displayed summaries and optionally requests additional summarization.

The user reads the deadline-indexed list and may select one summary for more detail.

The user enters a new prompt sentence such as “Explain this obligation in more detail for a non-expert, but keep it under three sentences.” into an input field associated with the selected summary.

The input to this step is the displayed list of summaries, and the output is a new user-generated prompt sentence and a selection of a target summary.

### Step 22:

The terminal sends the new prompt sentence and reference information to the server.

The terminal associates the new prompt sentence with an identifier of the selected rule document or summary.

The terminal creates a new communication message containing the prompt sentence and the reference identifier and transmits it to the server using the communication interface.

The input to this step is the new prompt sentence and reference identifier, and the output is a new request message that triggers another cycle of analysis and generative summarization on the server.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented techniques for processing legislative documents typically apply fixed natural language processing pipelines and static rule sets to generate summaries or keyword lists. These techniques suffer from several technical limitations in the context of large-scale, deadline-centric legal information management on general-purpose computing hardware.
First, existing systems generally treat legislative text as unstructured strings and do not reliably transform complex linguistic constructs, such as nested parenthetical expressions, formal style phrases, or ambiguous date phrases, into machine-usable structured data. As a result, downstream components operating on commodity processors and memory often cannot correctly extract or normalize deadline information, which leads to inaccurate scheduling, inefficient database queries, and increased processing overhead for recalculation and manual correction.
Second, conventional summary engines typically generate the same type of summary regardless of run-time conditions on the computing system and do not adapt the level of detail or wording to the user's real-time emotional state or historical interaction pattern. From a computer-technology standpoint, this means that the system cannot optimize the behavior of the generative model invocation and the surrounding control logic based on feedback signals, causing redundant generations, unnecessary network round-trips to external AI services, and inefficient use of CPU, memory, and network bandwidth.
Third, known architectures often integrate generative models in an ad hoc manner: a summary is requested with a generic prompt, and the raw output is presented or stored without systematic structuring, deadline ordering, or feedback-driven template updates. Such architectures force the processor to perform repeated parsing, ad hoc post-processing, and client-side formatting, thereby degrading cache locality, increasing I/O between application tiers, and limiting the scalability of the system when managing a large corpus of legislative items and corresponding reminders for many users.
Fourth, most systems do not treat the prompt sentences for generative AI models as first-class, dynamically tunable control data. Prompt sentences are generally hard-coded and independent of logs of user interactions stored in memory and persistent storage. Consequently, the processor cannot use historical signals such as browsing history, detail-view counts, or summary-selection patterns to tune future prompts. This prevents the system from converging to a more efficient operating point in which fewer model calls, shorter responses, and simpler renderings are sufficient to satisfy a specific user's information needs.

Accordingly, there is a need for a computer-implemented system and method that, on a general-purpose processing platform, (i) normalizes and structurally analyzes legislative text in a form suitable for programmatic deadline extraction, (ii) orchestrates interactions with a generative AI model via machine-generated prompt sentences, (iii) dynamically adjusts the prompt content and summary detail based on emotion analysis signals and stored usage histories, and (iv) uses these adjusted summaries and normalized deadlines to manage deadline-ordered storage, retrieval, and reminder transmission in a computationally efficient and scalable manner.

The specific processing by the specific processing unit 290 of the data processing device 12 in Application Example 2 is realized by the following means.

The present invention provides a server comprising a processor and associated memory, the processor being configured to execute instructions that cause the server to (i) acquire, as input information, text of legislative documents from a user terminal; (ii) normalize the acquired text by using pattern matching and character string processing to produce normalized text; (iii) analyze the normalized text using a natural language processing engine to perform syntactic analysis and to generate structured data including at least a subject, an obligation content, and a deadline expression; (iv) construct, on the basis of the structured data and the normalized text, a prompt sentence that encodes requirements for summarization and deadline extraction, and transmit a request including the prompt sentence to a generative AI model to request generation of summary information; (v) receive response information from the generative AI model, parse the response information to extract summary information of the legislative document and normalized deadline information, and store the extracted information in a storage device in association with user identification data; (vi) organize a plurality of pieces of summary information in deadline order according to the normalized deadline information and maintain a deadline-ordered index in the storage device; (vii) obtain, from at least one of visual information, audio information, input operation information, and text information, emotion-analysis input data, and execute emotion-analysis processing to estimate a user emotional state; (viii) dynamically adjust content of the prompt sentence and a detail level of the summary information on the basis of the estimated user emotional state and usage history data stored in the storage device, thereby generating emotion-adaptive and user-specific prompt templates for subsequent invocations of the generative AI model; (ix) generate presentation data that formats the summary information and the deadline information according to the adjusted detail level and transmit the presentation data to the user terminal for display; (x) compare the normalized deadline information with a current time to identify legislative items falling within a predetermined period before a deadline, and generate notification information for the identified items; and (xi) transmit reminder information derived from the notification information to the user terminal via a communication interface. This enables the server to improve computer functionality by automatically transforming complex legislative text into structured, deadline-centric data; by orchestrating generative AI model interactions with dynamically tuned prompt sentences driven by emotion analysis and historical usage; by reducing redundant processing and network overhead through user-specific prompt and summary adaptation; and by efficiently managing deadline-ordered storage, retrieval, and reminder scheduling on general-purpose computing hardware.
The term “legislative document” refers to a text that defines rights, obligations, procedures, or standards issued by a public authority, including statutes, regulations, rules, ordinances, and similar normative provisions.
The term “text of a legislative document” refers to character string data representing at least a portion of a legislative document, including headings, articles, paragraphs, clauses, and annotations, in a machine-readable format.
The term “normalize” refers to processing text data by applying transformations such as removal of extraneous characters, unification of character formats, standardization of punctuation, and conversion of numerals or dates into a consistent representation.
The term “pattern matching” refers to processing for detecting or replacing character sequences in text based on a predefined pattern, such as a regular expression or template, executed by a computing device.
The term “character string processing” refers to operations performed on text data in memory, including concatenation, splitting, trimming, replacement, case conversion, and similar manipulations of character sequences.
The term “natural language processing engine” refers to a software component executed by a processor that analyzes human language text to determine linguistic attributes, such as tokenization, part-of-speech tagging, syntactic structure, and semantic relationships.
The term “syntactic analysis” refers to processing that determines grammatical structure of text, including identification of tokens, phrases, dependencies, and sentence boundaries, to represent the text in a structured form.
The term “structured data” refers to information organized in a predefined format, such as key-value pairs, records, or hierarchical objects, that can be processed programmatically by a computing device.
The term “subject” refers to an entity identified in a legislative document as bearing an obligation, right, or role, such as a person, organization, or category of actor.
The term “obligation content” refers to information in a legislative document that specifies an action, behavior, or condition that the subject is required, permitted, or prohibited to perform.
The term “deadline expression” refers to a portion of text that indicates a time limit, due date, effective date, period, or temporal condition relating to the obligation content in a legislative document.
The term “prompt sentence” refers to a sequence of instructions, context information, and formatting requirements expressed as text and provided as input to a generative AI model to control the behavior and output format of the model.
The term “generative AI model” refers to a computational model that generates text or other content in response to input, based on machine-learned parameters obtained from training on data, and that can perform tasks such as summarization, explanation, or transformation of text.
The term “summary information” refers to text or structured data that represents a condensed form of content extracted from a legislative document, focusing on essential elements such as subject, obligation content, and deadline expression.
The term “normalized deadline information” refers to deadline-related data derived from a deadline expression and converted into a unified representation, such as a standardized date or time interval format, suitable for computation and comparison.
The term “storage device” refers to any non-transitory computer-readable medium, such as a magnetic storage unit, optical storage unit, semiconductor memory, or distributed storage system, capable of storing data for access by a processor.
The term “deadline-ordered index” refers to a data structure that organizes references to legislative items or summaries according to associated deadline information, such that retrieval operations can access items in order of deadlines.
The term “visual information” refers to data obtained from an imaging sensor, such as a camera, representing images or video of a user or user environment.
The term “audio information” refers to data obtained from an acoustic sensor, such as a microphone, representing sound produced by or in proximity to a user.
The term “input operation information” refers to data relating to user interactions with an input interface, such as keypress sequences, pointer movements, touch gestures, input speed, and input error patterns.
The term “text information” refers to character string data produced or selected by a user, including queries, comments, and responses, that can be analyzed by a computing device.
The term “emotion-analysis input data” refers to one or more of visual information, audio information, input operation information, and text information that are used as input to a computational process for estimating a user emotional state.
The term “emotion-analysis processing” refers to computational operations that classify or score emotion-related attributes of a user based on emotion-analysis input data, using rule-based methods, statistical models, or machine-learned models.
The term “user emotional state” refers to an estimated affective condition of a user, such as stress, relaxation, frustration, or engagement, represented in categorical or numerical form for use in system control.
The term “usage history” refers to data stored in a storage device that records past interactions between a user and the system, including browsing patterns, viewed items, durations, selections, and explicit or implicit feedback.
The term “detail level of the summary information” refers to a degree of granularity or verbosity of summary information, including an amount of included explanation, examples, citations, and subordinate conditions.
The term “prompt template” refers to a base structure of a prompt sentence, including placeholders and controllable parameters for content such as summary length, terminology level, and output format, which can be instantiated or modified by a processor.
The term “presentation data” refers to data that defines a representation of information for output on a user interface, including text, layout metadata, formatting attributes, and control signals.
The term “current time” refers to temporal information obtained from a time source accessible by a computing device, such as a system clock, representing at least a current date or date and time.
The term “notification information” refers to data indicating that a particular legislative item or summary satisfies a condition for alerting a user, including identifiers of the item, deadline information, and a notification message.
The term “reminder information” refers to information transmitted to a user terminal for the purpose of alerting the user to a deadline, obligation, or event derived from a legislative document, and including at least part of the notification information.
The term “user terminal” refers to an information processing apparatus operated by a user, such as a smartphone, tablet, personal computer, or other client device, capable of communicating with the server and presenting information.
The term “communication interface” refers to hardware and software components that enable data exchange between the server and external devices or networks, including network adapters, communication protocols, and associated drivers.
The term “browsing history” refers to records indicating which information items or screens a user has accessed, including identifiers, timestamps, and access durations.
The term “detail-view count” refers to a numerical value indicating how many times a user has requested or accessed detailed information for a particular legislative item or summary.
The term “summary-selection history” refers to data indicating which among multiple available summaries or summary styles a user has selected or viewed over time.
The term “user-specific summary information” refers to summary information generated or selected by a system in accordance with attributes, preferences, emotional states, or usage history associated with a particular user.

In one embodiment, a server, a terminal, and a communication network cooperate to implement a legislative information management system that performs normalization, structured analysis, generative summarization, emotion-adaptive prompt control, deadline ordering, and reminder transmission. The server includes at least one processor, a main memory, a non-transitory storage device, and a communication interface. The terminal includes at least one processor, a display device, an input device, and optionally a camera and a microphone.

The server executes a program stored in the storage device and loaded into memory. The program is implemented, for example, in a high-level language such as Python or a similar language, and is executed on a general-purpose operating system. The server uses a natural language processing library such as spaCy or a similar engine to perform syntactic analysis, and uses a deep-learning framework such as a transformer-based generative AI model implemented on a neural network architecture. The server uses a database management system such as a relational database to store structured data, indexes, and logs.

The server receives, via the communication interface, text of legislative documents transmitted from the terminal. The server stores the received text in the storage device in association with a user identifier. The server then performs normalization of the received text by using character string processing functions and pattern matching. For example, the server uses a regular expression engine to detect and convert full-width numerals to half-width numerals, to standardize date formats, and to remove extraneous control characters. The server uses such normalization to convert heterogeneous legislative text into a canonical representation. This canonical representation reduces branching complexity in downstream parsing routines and improves cache locality when multiple legislative texts share canonical patterns.

The server then uses a natural language processing engine, such as a spaCy pipeline or an equivalent model, to perform tokenization, part-of-speech tagging, lemmatization, and dependency parsing on the normalized text. The server allocates a data structure in memory, such as an object graph or a record, to store, per legislative sentence: an array of tokens, an adjacency list representing dependency relations, and labels for syntactic roles. The server applies rule-based extraction logic on this dependency graph to identify candidates for a subject, an obligation content, and one or more deadline expressions. For instance, the server identifies a noun phrase that acts as a grammatical subject of a main verb as a candidate subject, identifies verb phrases and subordinate phrases attached to the verb as obligation content, and identifies temporal expressions or date-related patterns as deadline expressions.

The server converts these extracted elements into structured data, for example, key-value pairs stored in memory and persisted into the storage device. The structured data includes at least (subject, obligation_content, deadline_expression, law_reference_id). The server maintains indexes over these fields in the database such that queries constrained by deadlines or subjects can be resolved using B-tree or similar index structures. This structured representation allows the server to perform set operations and deadline-ordered queries directly on numeric or normalized temporal fields rather than on raw strings, which reduces computation time and I/O overhead.

The server then constructs a prompt sentence for a generative AI model. The server generates the prompt sentence by combining a prompt template stored in the storage device with the structured data. The prompt template includes slots for subject, obligation content, deadline expression, and requested output format. The server fills the slots with the extracted elements and with additional control parameters such as desired length, terminology level, and explicit instructions about output structure.

In one example, when the server estimates that the user is stressed, the server generates the following prompt sentence:
“Summarize the following legislative sentence in very simple and concise language. Focus only on who must do what and by when. Avoid legal jargon and keep the summary within two short sentences. Also provide a single normalized deadline date in the form ‘YYYY-MM-DD’. Legislative sentence:‘Under Article 25.1 of the Income Tax Law, salaried employees are required to file an income tax application by December 31 of each year’”

In another example, when the server estimates that the user is relaxed, the server generates the following prompt sentence:
“Provide a detailed yet clear summary of the following legislative sentence. Explain who is obligated, what the obligation is, the legal basis, and by when the obligation must be fulfilled. Use plain language but include the article reference. Also output the deadline date in the form ‘YYYY-MM-DD’. Legislative sentence: ‘Under Article 25.1 of the Income Tax Law, salaried employees are required to file an income tax application by December 31 of each year’”

The server transmits the prompt sentence and, optionally, the structured data to the generative AI model via an API call. The generative AI model is implemented, for example, as a transformer-based neural network having multiple self-attention layers, feed-forward layers, and layer-normalization components. The generative AI model is trained on a corpus of text, including legal and non-legal text, by minimizing a loss function such as cross-entropy between predicted tokens and target tokens, using stochastic gradient descent or an adaptive optimizer. The model parameters, including weight matrices and bias terms, are stored in a model storage and loaded into GPU or CPU memory for inference. The server uses a sequence-to-sequence decoding algorithm, such as greedy decoding or beam search with a limited beam width, to obtain an output sequence representing the summary and, if requested, structured fields such as a normalized date.

The server configures the generative AI model with parameters such as maximum output length, temperature, and top-k or top-p sampling thresholds. Unlike a human summarizer, the generative AI model operates according to learned numerical parameters and attention weights, rather than human legal reasoning. The server uses the prompt sentence to direct the model to produce machine-parseable or semi-structured output, such as labels “Summary:” and “Deadline date:”, which are easier for the server to parse programmatically. This design yields improved computational efficiency because the server does not need to implement an additional natural language understanding layer to interpret unstructured free-form output.

The server receives the output text from the generative AI model and parses it using pattern-based extraction and, optionally, additional natural language processing. The server locates segments following keywords like “Summary:” and “Deadline date:” and applies a date parser to the deadline field. The server validates that the parsed deadline complies with a specified format. If validation fails, the server can fall back to rule-based parsing of the original deadline expression to ensure robustness. The server then stores the summary information and the normalized deadline information as records in the storage device. Each record is associated with the user identifier and includes fields such as summary_text, deadline_date, subject, obligation_content, emotional_state, and prompt_template_id.

The server additionally maintains a deadline-ordered index, for example an index over the deadline_date field. When the server stores a new record, the database updates the index. This configuration allows the server to retrieve upcoming obligations by executing a range query constrained by date, which is processed efficiently by the index. The server thereby reduces the computational complexity of scanning all records and improves response time compared to an implementation that performs string-based filtering on unnormalized text.

The terminal presents the summary information and associated deadline information to the user via the display device. The terminal receives from the server data indicating the summary text, the deadline date, the emotion state, and presentation parameters. When the emotion state indicates stress, the terminal can display only minimal fields with a simplified layout. When the emotion state indicates relaxation, the terminal can display additional context such as the legal basis and explanatory comments. By tailoring the layout to the emotion state, the terminal can reduce visual clutter and required reading time when the user is stressed, which in turn can decrease the frequency of user-triggered clarification requests and reduce subsequent server load.

The server also estimates the user emotional state. The terminal acquires, via the camera, images of the user, and via the microphone, audio of the user's speech. The terminal measures input operation information such as typing speed and correction patterns. The terminal transmits these data, or features derived from them, to the server, or to an emotion-analysis component. The server performs emotion-analysis processing using, for example, a neural network classifier trained on multimodal features. The classifier may be implemented as a convolutional neural network for images, a recurrent or transformer-based network for audio features, and a fully connected layer that combines modalities. The server uses features such as facial action units, speech prosody parameters, and typing rhythm statistics. The classifier outputs a probability distribution over emotion classes such as stressed, relaxed, or neutral, and the server selects the dominant class as the user emotional state.

Alternatively, or additionally, the server derives the user emotional state from text information entered by the user. The server applies a text-based sentiment analysis model or rule-based polarity scoring to user queries or feedback. The server stores the estimated emotional state, along with timestamps and context, in the storage device. The server later uses this stored information as part of the usage history when adjusting prompt templates.

The server accumulates usage history, including which summaries the user has opened, how long each summary has been displayed, how often the user has requested additional details, and which summary style (concise or detailed) has been selected when options are provided. The server calculates statistics such as average preferred summary length, proportion of times the detailed view is opened, and frequency of deadline-related interactions. The server stores these statistics as per-user profiles in the storage device.

The server modifies the prompt templates over time based on the usage history and the emotional states. For example, when the server determines that a particular user consistently reads only concise summaries and rarely opens detailed views, the server updates the prompt template to reduce the requested length, to avoid unnecessary citations, and to prioritize explicit deadline mentions. The server writes updated template parameters to the storage device and associates them with the user identifier. On subsequent calls to the generative AI model, the server uses the updated template to construct prompt sentences. This adaptive mechanism reduces the average output length, which decreases the number of tokens generated by the model and thereby reduces inference time and network transfer size. As a result, the server improves system throughput and reduces resource consumption.

The server also supports customized prompt sentences provided by the user. The terminal presents an advanced configuration interface in which the user may input a free-form instruction describing how the summary should be generated. For example, the user may input:
“Please summarize the following law in three bullet points focusing on who must act, by when, and what the consequences are.”

The terminal transmits this customized prompt sentence along with the legislative text to the server. The server incorporates the customized prompt into the base prompt template, for example by embedding it into an instruction section, and then transmits the resulting prompt sentence to the generative AI model. The server then receives and parses the model output and stores the summary in association with the user and the prompt identifier. This mechanism allows the server to generate user-configurable summaries while maintaining the technical advantages of structured analysis and normalized deadlines. The server can also compare the performance and user engagement associated with system-generated prompt templates and user-customized prompts to further refine system behavior.

The server generates notification information based on the normalized deadline information. The server obtains the current time from a system clock and compares it numerically with each stored deadline_date. When the difference between the current date and a deadline date falls within a predetermined threshold, the server registers a reminder event in the storage device. The server prepares reminder messages using templates that include the summary text and deadline date, and transmits the reminder information to the terminal via the communication interface. The terminal displays the reminder as a notification or in-app message. When the user acts on the reminder, for example by confirming that a filing or payment has been completed, the terminal sends completion status data back to the server. The server updates the corresponding record to mark the obligation as completed and suppresses further reminders for that deadline. This closed-loop control reduces redundant communication and avoids unnecessary notification transmissions.

In another embodiment, the server is configured to operate with different types of generative AI models. For example, the server may use a large-scale, cloud-hosted transformer model for initial deployments, and may later switch to a locally deployed, distilled transformer model with fewer layers and parameters for reduced latency and lower resource consumption. In either case, the server adapts the prompt sentence to match the model's capabilities. The server may also apply model-ensemble techniques, in which a first model generates a draft summary and a second, smaller model verifies structure or checks for required fields (subject, obligation, deadline). Such an arrangement can further improve reliability and reduce error rates in deadline extraction.

In a further embodiment, the server assigns priority levels to different processing tasks. For example, deadline extraction and reminder scheduling may be given higher priority than generation of highly detailed explanations. The server's scheduling logic in the operating system can allocate more CPU time to deadline-related tasks during peak periods. Because the system uses normalized, indexed deadlines and compact structured representations, the server can efficiently handle a large number of legislative items without a linear scan of the entire corpus. This technical effect is not merely automation of manual review but a rearrangement and optimization of data structures and algorithmic steps tailored to deadline-centric processing.

The described system provides technical improvements over traditional computer-based legal information systems. By transforming legislative text into structured, deadline-centric data using NLP-driven parsing and canonicalized representations, the server allows efficient use of indexes and deadline-range queries. By treating prompt sentences as dynamically adjustable control data driven by emotion-analysis results and usage history, the server reduces unnecessary model invocations and response sizes, thereby decreasing computational load and network traffic. By integrating a generative AI model whose outputs are constrained by structured prompts and validated by rule-based post-processing, the server increases the accuracy and robustness of deadline extraction compared to simple keyword-based methods. These technical configurations contribute to improvement of computer functionality in terms of processing speed, resource utilization, and reliability, beyond a mere automation of human legal reading.

Alternative embodiments may include different emotion-analysis models, different neural network architectures, different database systems, or different normalization rules, while still employing the core approach of structured analysis, generative summarization controlled by prompt sentences, emotion-and history-based template adaptation, and deadline-ordered management. For example, the server may use a recurrent neural network with attention instead of a transformer for summarization, or may store structured data in a key-value store rather than a relational database. The terminal may be a head-mounted display or other specialized device instead of a conventional smartphone. These variations still rely on the same technical principle: the cooperative operation of a server, terminal, and generative AI model configured so that prompt sentences, structured legislative data, and user-specific parameters control machine processing pathways inside the computing system to achieve improved efficiency, accuracy, and scalability.

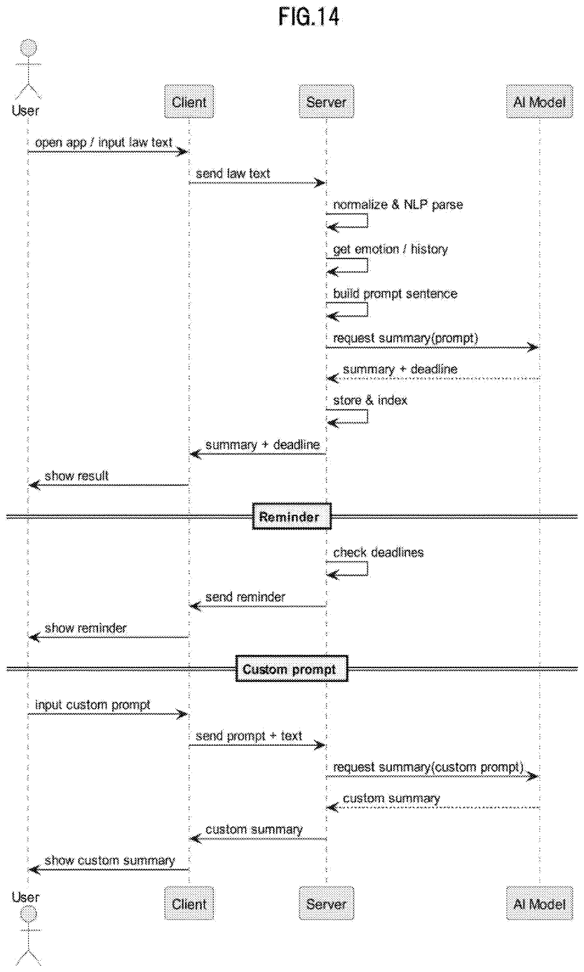

The following describes the processing flow using FIG. 14.

### Step 1:

User operates the terminal to launch an application and to provide legislative text.

User inputs a legislative sentence or document fragment into a text field or via speech-to-text.
Input: raw character string representing legislative text, optionally accompanied by a user identifier.

Terminal captures the input event, converts speech to text if necessary, and creates a request object including the text and metadata such as language and timestamp.
Output: structured request data containing the legislative text and metadata, ready for transmission to the server.

### Step 2:

Terminal transmits the legislative text and metadata to the server.

Terminal uses an HTTP client library to send the request object as an HTTPS POST to a server endpoint.
Input: request data including user ID, legislative text, language, and timestamp.

Terminal serializes the request data into a JSON payload and attaches appropriate headers.
Output: network message containing the request payload delivered to the server via the communication network.

### Step 3:

Server receives and logs the raw legislative text.

Server accepts the HTTPS request through a web application framework, decodes the JSON payload, and extracts the fields.
Input: JSON payload with user ID, legislative text, language, and timestamp.

Server generates a unique request identifier, obtains a server-side timestamp, and inserts a record into a logging table in a storage device.
Output: persistent log entry associating the user, the request ID, the original text, and the time of receipt.

### Step 4:

Terminal captures emotion-related data and sends it to the server.

Terminal acquires visual data from a camera, audio data from a microphone, and interaction data from input devices during user input.
Input: raw image frames, audio samples, and input operation metrics such as typing rate and error count.

Terminal either preprocesses these data into features (for example, facial landmarks, audio energy, inter-key timing) or sends the raw data to an emotion-analysis endpoint on the server.
Output: emotion-analysis request data, labeled with the user ID and request ID, transmitted to the server.

### Step 5:

Server estimates the user emotional state.

Server executes an emotion-analysis model that consumes the received multimodal data or extracted features.
Input: emotion-analysis input data including visual features, audio features, and input operation information.

Server applies a classifier, such as a neural network trained on emotion-labeled data, to compute a probability distribution over emotion classes, then selects the class with the highest probability as the emotional state.
Output: emotion state data including an emotion label (for example, “stressed” or “relaxed”) and confidence scores, stored in association with the request ID.

### Step 6:

Server normalizes the legislative text.

Server retrieves the legislative text for the request from memory or storage and performs text-cleaning operations.
Input: raw legislative text string.

Server applies regular expressions and string-processing functions to remove extraneous whitespace, convert character widths, standardize punctuation, and unify date formats, thereby transforming the raw string into a canonical form.
Output: normalized legislative text string that is more suitable for deterministic parsing and downstream processing.

### Step 7:

Server performs syntactic and semantic analysis on the normalized text.

Server uses a natural language processing engine to tokenize the text, assign part-of-speech tags, and build a dependency parse tree.
Input: normalized legislative text.

Server constructs data structures such as token arrays and dependency graphs, then applies rule-based extraction logic to identify segments corresponding to subject, obligation content, and deadline expressions.

Output: structured analysis data containing identified subject, obligation content, deadline expressions, and any detected references to legal provisions.

### Step 8:

Server transforms the analysis result into structured data and stores it.

Server organizes the analysis output into a standardized schema, for example a record with named fields.
Input: output of the NLP engine including tokens, parse tree, and extracted entities.

Server populates a structured object or database record with fields for subject, obligation, deadline expression, and reference identifiers, then writes this record into a storage device using a database management system.
Output: persistently stored structured legislative record that can be indexed and queried.

### Step 9:

Server determines prompt-control parameters from emotion and usage history.

Server retrieves, from the storage device, past interaction statistics and prompt-template settings for the user, and combines them with the current emotion state.
Input: user-specific usage history data, stored prompt template, and current emotion state.

Server computes preferred detail level, terminology difficulty, and output length based on rules or learned mappings that relate emotion states and history metrics to control parameters.
Output: prompt-control configuration specifying required output format, length, and content emphasis for the current request.

### Step 10:

Server generates a prompt sentence for the generative AI model.

Server composes a natural-language instruction that encodes summarization requirements and structured elements from the analysis.
Input: structured legislative data (subject, obligation, deadline expression), normalized text, and prompt-control configuration.

Server fills a prompt template with these values, for example by inserting the legislative sentence, specifying whether the summary should be concise or detailed, and instructing the model to output a normalized deadline date.
Output: prompt sentence text that provides explicit guidance to the generative AI model regarding task and output structure.

### Step 11:

Server transmits the prompt sentence to the generative AI model and requests summary generation.

Server constructs a model-inference request, including the prompt sentence and model parameters, and sends it to the generative AI model endpoint.
Input: prompt sentence, model identifier, and decoding parameters such as maximum length and sampling settings.

Server initiates an inference call via a network protocol or local procedure, then waits for the model to produce output tokens representing the summary and deadline.
Output: response text from the generative AI model containing a generated summary and, if requested, an explicit deadline statement.

### Step 12:

Server parses the model response and extracts summary and deadline information.

Server processes the text produced by the generative AI model to separate logical sections such as the main summary and the normalized date.
Input: generated response text from the generative AI model.

Server applies pattern-based extraction or a lightweight parser to identify labeled segments, then uses a date parser to convert the deadline expression into a machine-readable date format, checking for compliance with expected patterns.
Output: summary text string and normalized deadline value, suitable for storage and chronological operations.

### Step 13:

Server stores summary records and updates deadline-ordered indexes.

Server creates a new summary record that associates the user, the legislative reference, the summary text, and the normalized deadline.
Input: extracted summary text, normalized deadline value, user ID, and structured legislative identifiers.

Server inserts this record into a summaries table in the storage device and triggers maintenance of an index on the deadline field so that deadline-based queries can be executed efficiently.
Output: indexed summary record available for fast retrieval in deadline order.

### Step 14:

Server selects presentation parameters and prepares display data based on emotion.

Server decides which version of the summary and which visual emphasis to use, using the current emotional state and stored user preferences.
Input: stored summary record, emotion state, and user presentation preferences.

Server generates a presentation payload containing the chosen summary text, deadline date, and metadata such as formatting hints (for example, highlight color for dates and visibility flags for detailed explanations).
Output: presentation data package sent to the terminal for display.

### Step 15:

Terminal renders the summary and deadline for the user.

Terminal receives the presentation data from the server and maps the fields to user interface elements.
Input: presentation data including summary text, deadline date, and formatting hints.

Terminal updates the display, draws textual elements, highlights the deadline, and, if configured, shows buttons or links for viewing more detail; terminal may adjust font size or layout depending on the emotion-specified mode.
Output: rendered user interface that presents the legislative summary and deadline in a form adapted to the user state.

### Step 16:

Server manages deadline-based reminder scheduling.

Server periodically scans stored summary records to identify deadlines that are approaching within a predefined time window.
Input: normalized deadline values, current time obtained from a system clock, and reminder configuration parameters.

Server computes time differences between the current time and each deadline, selects records that fall within the threshold, and generates notification entries in a reminder queue in the storage device.
Output: set of reminder events ready for transmission to terminals.

### Step 17:

Server generates and transmits reminder information to the terminal.

Server constructs reminder messages that reference the summary text and deadline and selects appropriate communication channels.
Input: reminder events including user ID, summary ID, and deadline date.

Server formats reminder content, such as a short message including the deadline, and sends it via a push-notification service or equivalent channel to the corresponding terminal.
Output: reminder messages delivered to terminals and recorded as sent in the server's reminder-log data structure.

### Step 18:

Terminal receives reminder notifications and opens the relevant summary for the user.

Terminal processes incoming reminder messages from the communication service and displays them to the user in a notification area.
Input: reminder message including a link or identifier for the related summary.

Terminal, upon user selection of the notification, requests the associated summary from the server and navigates directly to the corresponding display screen where the obligation and deadline are visible.
Output: focused user interface view that allows the user to review the impending obligation without manual search.

### Step 19:

User optionally provides a customized prompt sentence for advanced summarization.

User opens an advanced settings screen on the terminal and inputs a free-form instruction describing the desired summarization style.
Input: customized prompt text provided by the user and additional legislative text to be summarized.

Terminal packages the custom prompt text together with the legislative text and user identifier and sends them to the server for processing as a tailored request.
Output: custom-prompt request data available to the server for generating a specialized summary.

### Step 20:

Server incorporates the customized prompt sentence into the model-control process.

Server receives the customized prompt and merges it with or substitutes it for the system-generated prompt template.
Input: customized prompt sentence, legislative text, and user ID.

Server constructs a new prompt sentence that includes the user's instructions and any necessary system constraints, then sends this updated prompt to the generative AI model and repeats response parsing and storage as in earlier steps.
Output: user-specific summary generated according to the customized prompt, stored in association with the user and available for display.

### Step 21:

Server updates prompt templates based on accumulated behavior and emotion data.

Server analyzes logs of user interactions, such as which summaries were read, how long they were displayed, and how often detailed views were opened, together with stored emotion states at the time of interaction.
Input: usage history records, emotion state logs, and previous prompt template parameters.

Server computes updated control parameters, modifies the prompt templates accordingly, and writes the new templates back to the storage device so that future prompt generation uses these refined settings.
Output: adjusted prompt templates that represent learned preferences and support more efficient and accurate summarization for subsequent requests.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

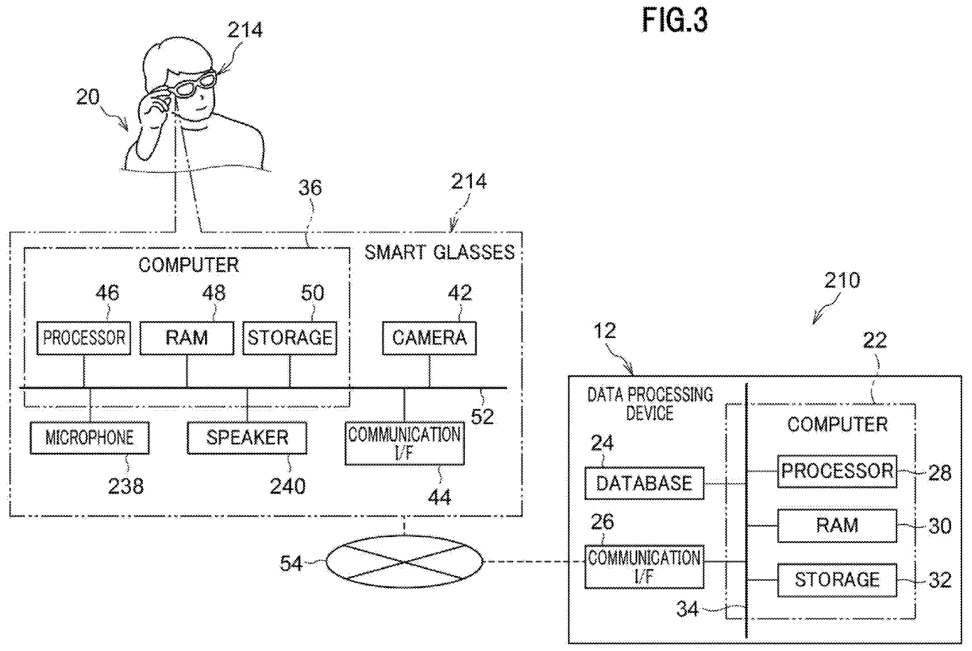

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

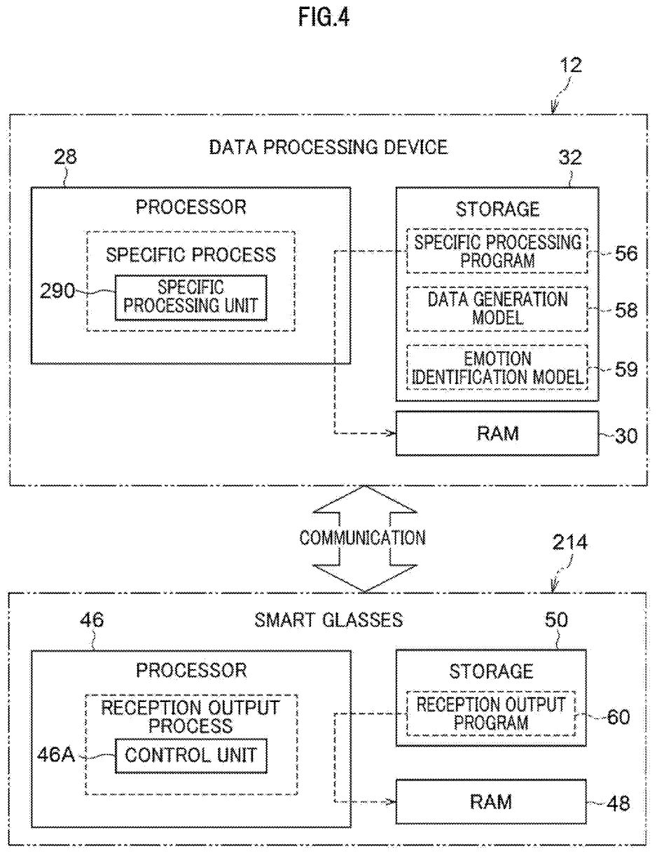

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

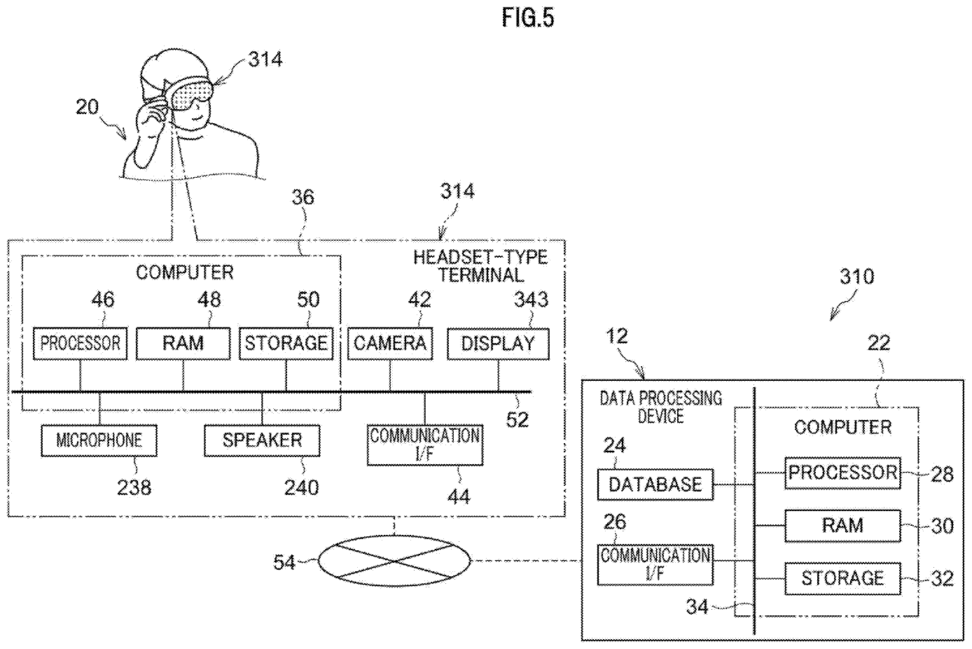

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

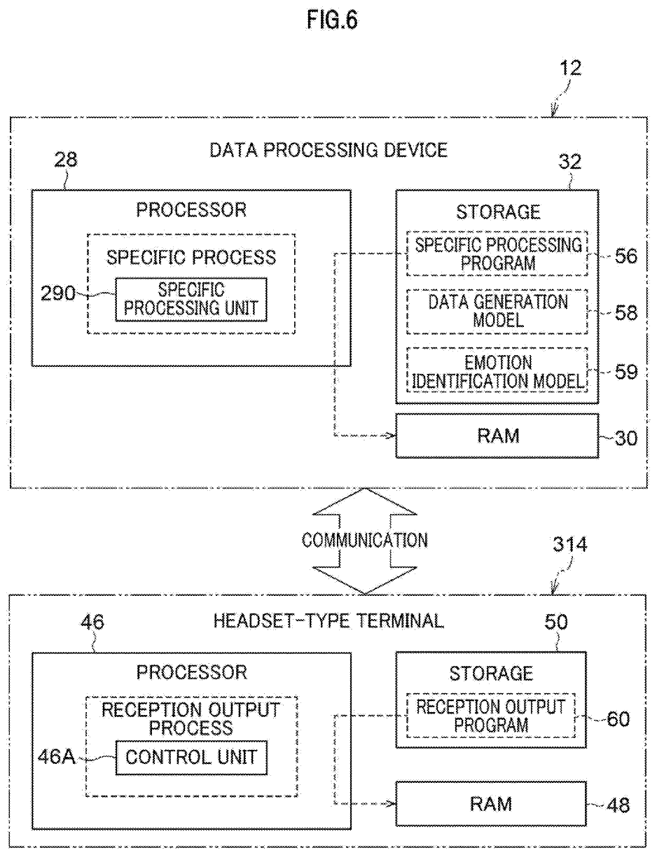

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

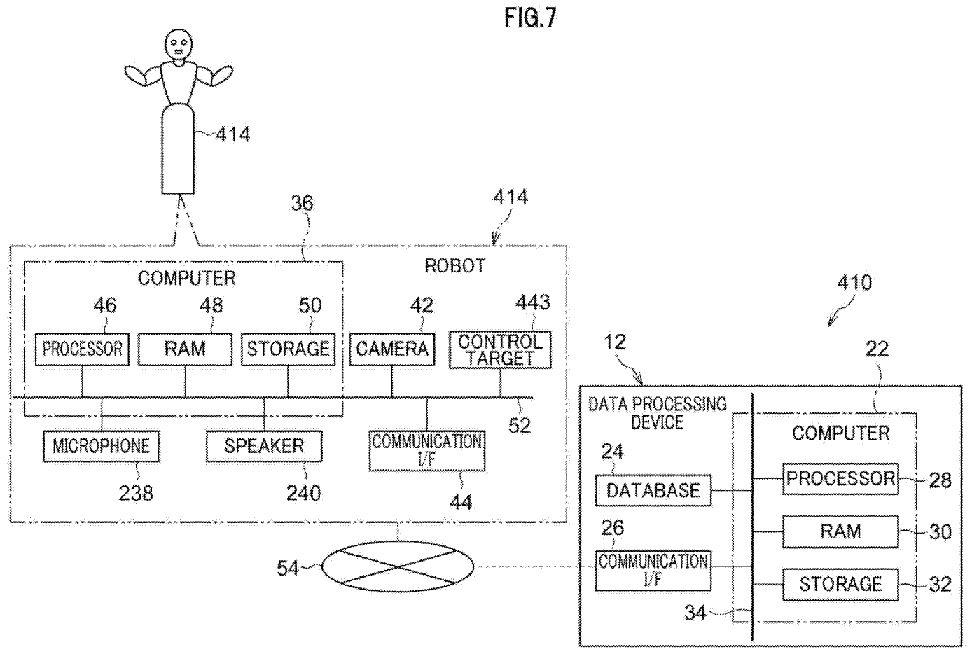

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

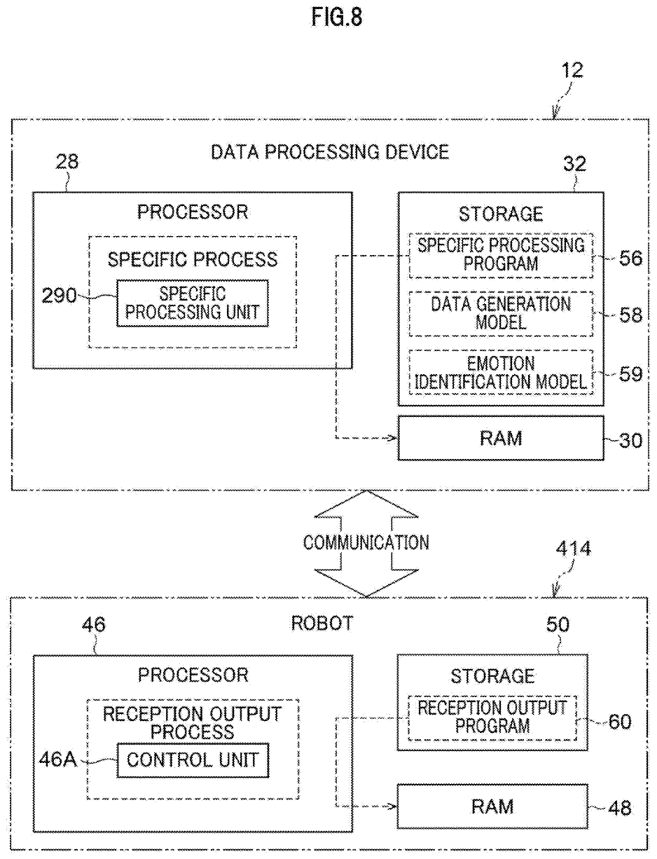

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

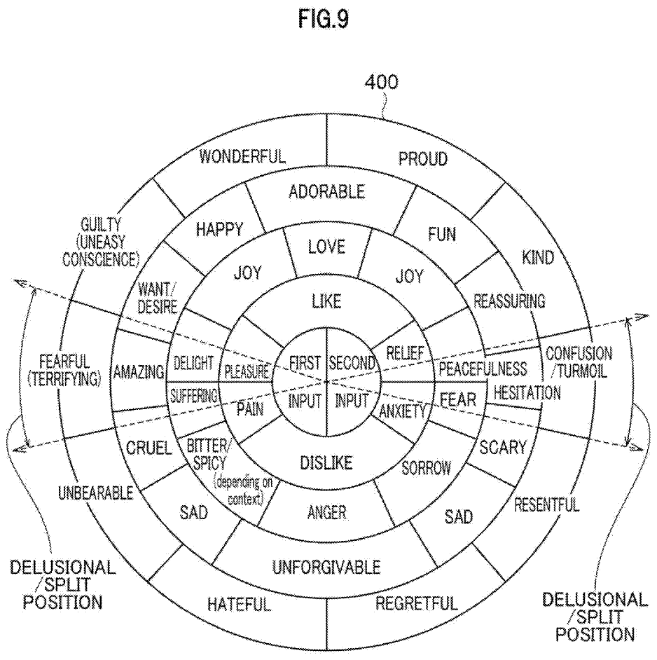

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

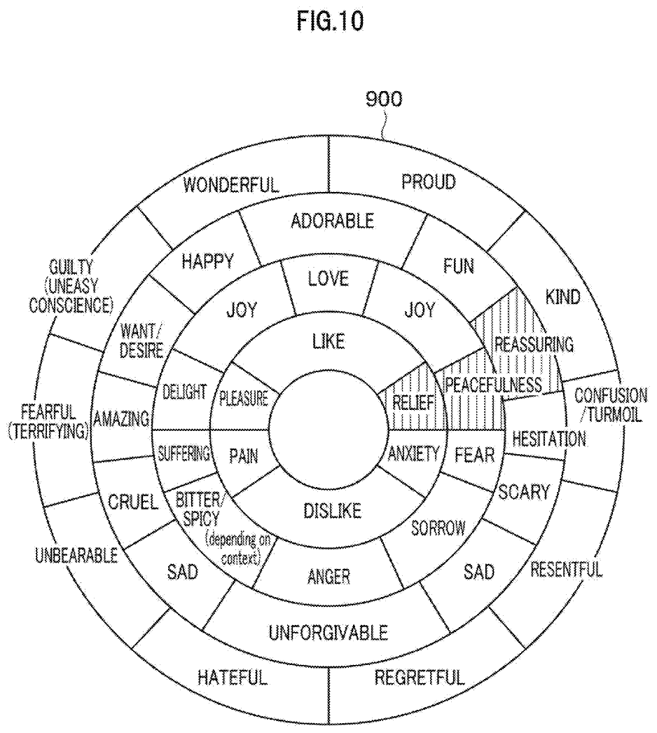

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
analyze a statutory document by using a natural language processing technique and extract linguistic elements including date expressions and information relating to deadlines, and
normalize, based on the extracted linguistic elements, a type of an effective date or an application deadline and a calendar date, and convert the calendar date into an internal format to store the date as deadline information, and
generate a prompt sentence to be input to a generative information processing model, based on a syntactic analysis result and the deadline information, and request the generative information processing model to perform summary generation and extraction of important information by using the prompt sentence, and
associate a summary result output from the generative information processing model with the deadline information, record the summary result and the deadline information in a data storage device, and manage the summary result and the deadline information for each statutory document, and
sort, for a plurality of statutory documents recorded in the data storage device, the summary results in chronological order based on the effective dates or the application deadlines, and acquire the summary results as a list, and
recognize an emotional state of a user and, by using an emotion processing mechanism, adjust at least one of the prompt sentence and a representation format of the summary result according to the emotional state, and
transmit the list and the summary result to an information terminal apparatus, and perform interactive processing in response to viewing by the user and additional inquiries from the user.

### Supplementary 2

The system according to supplementary 1,
wherein the processor is configured to
perform preprocessing on a statutory document having a formal expression, a numerical expression, and a sentence in which parentheses are multiply nested and form a complex structure, by using the natural language processing technique, and control input to the generative information processing model so that the complex structure is resolved in the prompt sentence.

### Supplementary 3

The system according to supplementary 1,
wherein the processor is configured to
adjust instruction content and an output length constraint in the prompt sentence to the generative information processing model so as to summarize the statutory document at a granularity that is more concise than text information obtained by a retrieval process and more easily understandable to the user than an explanation by a specialist, and present the summarized statutory document as the sorted list.

### Application Example 1

### Supplementary 1

A system comprising a processor,
wherein the processor is configured to
analyze a statute text by using a natural language processing technique and extract document structure information and deadline candidate information from the statute text,
request a generative information processing model to generate summary information and additional information based on the extracted document structure information, the extracted deadline candidate information, and a prompt sentence input by a user, and generate statute summary information and statute deadline information based on a response from the generative information processing model,
create a deadline information list including enforcement date information, application deadline information, or transitional period deadline information based on the generated statute summary information and the generated statute deadline information,
register schedule information corresponding to each deadline information included in the created deadline information list in a time management device or an external schedule management service,
generate notification information before arrival of each deadline based on the registered schedule information and transmit the notification information to a terminal device via a communication device,
update the registered schedule information or the deadline information list in response to input from the terminal device, and
estimate an emotion state of the user by an emotion recognition process and dynamically adjust the prompt sentence and summary conditions for the generative information processing model based on the estimated emotion state to control a presentation format or a detail level of the statute summary information.

### Supplementary 2

The system according to supplementary 1,
wherein the processor is configured to analyze a sentence including formal expression, numeric expression, and a bracket having a multiple nested structure in the statute text by character type normalization processing, clause segmentation processing, syntactic parsing processing, and expression normalization processing by using the natural language processing technique, and generate the document structure information including article-unit information, paragraph-unit information, and item-unit information.

### Supplementary 3

The system according to supplementary 1,
wherein the processor is configured to
request the generative information processing model to generate the statute summary information and the statute deadline information in accordance with a request content included in the prompt sentence from the user, compare existing statute information with updated statute information, identify new obligation information, changed obligation information, or deleted obligation information, and automatically add, change, or delete the registered schedule information in the time management device or the external schedule management service based on an identification result.

### Example 2

### Supplementary 1

A system comprising a processor,
wherein the processor is configured to
analyze a rule document by performing syntactic analysis and semantic analysis using a natural language processing technique,
input instruction information including a prompt sentence and an analysis result of the rule document into a generative information processing model, request generation of a summary from the generative information processing model, and extract important information of the rule document based on a summary generated by the generative information processing model,
extract deadline information from the generated summary, normalize the deadline information into a standard format using a date and time processing function, classify and sort the summary based on the deadline information, and structure output data for presentation,
recognize an emotional state of a user and, using an emotion processing function, adjust the prompt sentence and a summarization condition for the generative information processing model according to the emotional state so as to change a summarization method, and
receive, via a communication function, the rule document and the prompt sentence input from a terminal, and transmit the structured output data to the terminal.

### Supplementary 2

The system according to supplementary 1,
wherein the processor is configured to analyze, by the natural language processing technique, the rule document including formal expressions, quantity expressions, and a bracket structure in which brackets are nested in multiple levels, and summarize the rule document by the generative information processing model.

### Supplementary 3

The system according to supplementary 1,
wherein the processor is configured to
generate, by the generative information processing model, a summary that is more concise than an explanation created by a professional worker and more accurate than text information displayed by an information retrieval apparatus, and further present the summary in a list format based on the deadline information.

### Application Example 2

### Supplementary 1

A system comprising a processor,
wherein the processor is configured to
acquire, as input information, text of a legislative document,
normalize the acquired text of the legislative document by using pattern matching and character string processing,
analyze the normalized text of the legislative document by a natural language processing technique to perform syntactic analysis and to generate structured information including at least a subject, an obligation content, and a deadline expression,
generate a prompt sentence for a generative AI model on the basis of the structured information and the text of the legislative document, and request summary generation by transmitting a request including the prompt sentence to the generative AI model,
analyze response information received from the generative AI model to extract summary information of the legislative document and normalized deadline information,
organize a plurality of pieces of summary information of legislative documents in deadline order on the basis of the extracted deadline information, and store the organized summary information in a storage device,
estimate a user emotional state by applying at least one of visual information, audio information, input operation information, and text information to emotion analysis processing,
dynamically adjust content of the prompt sentence and a detail level of the summary information on the basis of the estimated user emotional state and a usage history,
present legislative information on a display device in a format corresponding to the user emotional state on the basis of the adjusted summary information and the deadline information,
compare the deadline information with a current time, extract summary information corresponding to a predetermined period before a deadline, and output notification information, and
transmit reminder information to a user terminal via a communication device on the basis of the notification information.

### Supplementary 2

The system according to supplementary 1,
wherein the processor is configured to acquire, from the user terminal, a customized prompt sentence for the generative AI model together with the text of the legislative document,
incorporate the customized prompt sentence into the prompt sentence used for requesting the summary generation, and store, in the storage device, summary information generated on the basis of the customized prompt sentence in association with a user.

### Supplementary 3

The system according to supplementary 1,
wherein the processor is configured to update a template of the prompt sentence, including at least a summary length, a terminology difficulty level, and a display format, on the basis of at least one of a browsing history, a detail-view count, and a summary-selection history stored in the storage device, and to use the updated template in a subsequent summary generation so as to generate user-specific summary information.

What is claimed is:

1. A system comprising:
circuitry configured to:
receive, via a communication interface coupled to a packet-switched network, a statutory document from a terminal device;
analyze the statutory document using a natural language processing algorithm to extract linguistic elements comprising date expressions, deadline-related phrases, syntactic structures, and obligation indicators;
normalize extracted date expressions and deadline-related phrases into an internal data format representing effective dates and application deadlines;
generate a prompt sentence for a generative neural network model based on syntactic analysis results and the normalized deadline information;
transmit the prompt sentence to the generative neural network model and acquire summary data and extracted important information from the generative neural network model;
associate and store the summary data with the normalized deadline information in a storage device, and sort stored statutory documents in chronological order based on effective dates or application deadlines to generate a chronological list; and
obtain emotion-state information of a user and adjust at least one of the prompt sentence and a representation format of the summary data based on the emotion-state information.

2. The system according to claim 1, wherein the circuitry is configured to apply the natural language processing algorithm to parse sentences containing formal expressions, numerical expressions, and nested parenthetical structures, and to convert parsed structures into an internal representation for downstream processing.

3. The system according to claim 2, wherein the circuitry is configured to identify subjects, obligations, prohibitions, conditions, temporal expressions, and cross-references within the statutory document during the parsing.

4. The system according to claim 3, wherein the circuitry is configured to generate the prompt sentence to include a document type identifier, a desired summary detail level, and one or more focus parameters specifying obligations or deadlines for the generative neural network model.

5. The system according to claim 4, wherein the circuitry is configured to store the prompt sentence and the corresponding summary data in the storage device as a training pair for fine-tuning the generative neural network model on domain-specific summarization.

6. The system according to claim 1, wherein the circuitry is configured to obtain the emotion-state information by processing at least one of facial image data, voice signal data, and text interaction data received from the terminal device using an emotion recognition model.

7. The system according to claim 6, wherein the circuitry is configured to determine an emotion label and a cognitive burden score from the emotion-state information, and to select a representation format for the summary data based on the emotion label and the cognitive burden score.

8. The system according to claim 7, wherein the circuitry is configured to adjust the prompt sentence to instruct the generative neural network model to generate a simplified summary when the cognitive burden score exceeds a threshold, and a detailed summary when the cognitive burden score is below the threshold.

9. The system according to claim 8, wherein the circuitry is configured to monitor changes in the emotion-state information over successive user interactions and update the representation format and prompt sentence parameters dynamically based on the monitored changes.

10. The system according to claim 1, wherein the circuitry is configured to transmit the chronological list to the terminal device, the chronological list comprising entries each associating a statutory document identifier, normalized effective date, normalized deadline, and corresponding summary data.

11. The system according to claim 10, wherein the circuitry is configured to receive a filtering request from the terminal device specifying a date range, and to retrieve from the storage device entries satisfying the date range based on the normalized deadline information.

12. The system according to claim 11, wherein the circuitry is configured to transmit filtered entries to the terminal device as display-structured data formatted for rendering on a display device of the terminal device.

13. The system according to claim 12, wherein the circuitry is configured to receive a selection input from the terminal device identifying a statutory document in the chronological list, and to retrieve and transmit detailed summary data associated with the selected statutory document from the storage device.

14. The system according to claim 1, wherein the circuitry is configured to store interaction history comprising prior prompt sentences, user emotion-state information, and corresponding summary data, and to incorporate the interaction history into subsequently generated prompt sentences to improve summarization consistency.

15. The system according to claim 14, wherein the circuitry is configured to retrieve, from the interaction history, a prior emotion label and a prior representation format, and to apply the prior representation format as an initial format for a subsequent summarization operation when the prior emotion label matches a current emotion label.

16. The system according to claim 1, wherein the circuitry is configured to evaluate the summary data against one or more content quality criteria comprising factual consistency with the statutory document and completeness of obligation coverage, and to regenerate the summary data when the evaluation fails a quality threshold.

17. The system according to claim 1, wherein the circuitry is configured to detect anomalous deviation between the summary data and the statutory document using an autoencoder model trained on normal-quality summary pairs, and to initiate a remedial summarization operation when a reconstruction error exceeds a predetermined threshold.

18. A system comprising:
circuitry configured to:
receive, via a communication interface coupled to a packet-switched network, a statutory document from a terminal device;
apply a natural language processing pipeline to the statutory document to extract date expressions, deadline phrases, syntactic structures, and obligation indicators, and normalize extracted date expressions and deadline phrases into an internal data format;
construct a prompt sentence for a generative neural network model based on syntactic analysis results and normalized deadline information, the prompt sentence specifying a document type, a detail level, and one or more obligation or deadline focus parameters;
transmit the prompt sentence to the generative neural network model and receive summary data comprising extracted important information;
associate the summary data with the normalized deadline information in a storage device and sort stored documents in chronological order to generate a chronological list for transmission to the terminal device; and
obtain emotion-state information of a user by processing sensor data from the terminal device using an emotion recognition model, determine an emotion label and a cognitive burden score, and adjust at least one of the prompt sentence and a representation format of the summary data based on the emotion label and the cognitive burden score.

19. The system according to claim 18, wherein the circuitry is configured to select a simplified representation format when the cognitive burden score exceeds a predetermined threshold, and a detailed representation format when the cognitive burden score is below the predetermined threshold, and to transmit the summary data in the selected representation format to the terminal device.

20. A method comprising:
receiving, via a communication interface coupled to a packet-switched network, a statutory document from a terminal device;
analyzing the statutory document using a natural language processing algorithm to extract linguistic elements comprising date expressions, deadline-related phrases, syntactic structures, and obligation indicators;
normalizing extracted date expressions and deadline-related phrases into an internal data format representing effective dates and application deadlines;
generating a prompt sentence for a generative neural network model based on syntactic analysis results and the normalized deadline information;
transmitting the prompt sentence to the generative neural network model and acquiring summary data and extracted important information from the generative neural network model;
associating and storing the summary data with the normalized deadline information in a storage device, and sorting stored statutory documents in chronological order based on effective dates or application deadlines to generate a chronological list; and
obtaining emotion-state information of a user and adjusting at least one of the prompt sentence and a representation format of the summary data based on the emotion-state information.
